(19) United States
(12) Patent Application Publication
(10) Pub. No.: US 2011/0007123 A1
(43) Pub. Date: Jan. 13, 2011

(54) THERMAL TRANSFER SHEET AND IMAGE FORMATION METHOD USING SAME

(75) Inventors: Hisato Nagase, Minami-ashigara-shi (JP); Junichiro Hosokawa, Minami-ashigara-shi (JP); Hideyuki Shirai, Minami-ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: Fujifilm Corporation, Minato-ku, Tokyo (JP)

(21) Appl. No.: 12/920,232

(22) PCT Filed: Feb. 27, 2009
(86) PCT No.: PCT/JP2009/054222

§ 371 Date: Aug. 30, 2010

(30) Foreign Application Priority Data
Feb. 29, 2008 (JP) 2008-049976

(51) Int. Cl. B41J 2/325; B41M 5/26; B41M 5/34

(52) U.S. Cl. 347/215; 428/32.86; 428/32.75

(57) ABSTRACT

A thermal transfer sheet having a dye layer containing a thermo-transferable dye in a binder resin, wherein the dye layer contains at least one polymer containing a repetitive unit derived from (a) a monomer of the following formula (1) and (b) a monomer having an aliphatic group that has a bridging linkage and has at least 7 carbon atoms:

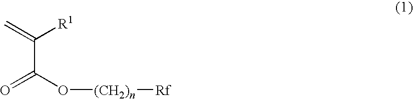

wherein Rf represents substituent containing a fluoroalkyl or perfluoroalkyl group having at least 8 fluorine atoms, n indicates 1 or 2, and R¹ represents a hydrogen atom or a methyl group.

### TECHNICAL FIELD

The present invention relates to a thermal transfer sheet and an image formation method capable of solving a problem of printing failure and providing high-quality prints.

### BACKGROUND ART

Heretofore, various thermal transfer recording methods are known. Above all, a dye diffusion transfer recording system is specifically noted as a process capable of producing color hard copies of which the image quality is the nearest to that of silver salt photographs. Moreover, as compared with silver salt photographs, the system has other various advantages in that it is a dry system, it can produce visible images directly from digital data, and it is simple in image duplication.

In the dye diffusion transfer recording system, a dye-containing thermal transfer sheet (hereinafter referred to as “ink sheet”) and a thermal transfer image-receiving sheet (hereinafter referred to as “image-receiving sheet”) are put one upon another, and the ink sheet is heated with a thermal head from which the heat generation is controlled by electric signals give thereto, whereby the dye in the ink sheet is transferred onto the image-receiving sheet for image information recording thereon. In this, three colors of cyan, magenta and yellow, or four colors of these and black are recorded as superimposed, thereby giving a color image having a continuously changing color density in a mode of transfer recording.

From the viewpoint of enhancing the colorability in this system, use of various dyes is proposed (for example, see Patent References 1 to 4). However, as compared with silver salt photographs that have a long history as color print materials, the system is problematic in that the possibility of image failure occurrence in continuous processing of the produced images is high. Especially with the recent tendency toward high-speed printing in the art, the printing procedure requires a large quantity of heat, therefore bringing about problems of transfer failure as thermal transfer sheets continuously processed in large quantities may be wrinkled, and printing failure as thermal transfer sheets and thermal transfer image-receiving sheets may fuse or adhere together and could not be smoothly peeled away from each other.

For preventing thermal transfer sheets and thermal transfer image-receiving sheets from fusing or adhering together, proposed are a method of using a graft polymer having a silicone-based lubricant segment as a lubricant or a binder resin (Patent References 5, 6), a method of adding fine particles of a mat agent to a thermal transfer sheet and/or a thermal transfer image-receiving sheet (Patent Reference 7), and a method of making a fluoropolymer resin exist locally in the surface layer part of a dye layer (Patent Reference 8).

Patent Reference 1: JP-A 7-232482

Patent Reference 2: JP-A 5-221161

Patent Reference 3: JP-A 4-357088

Patent Reference 4: JP-A 62-55194

Patent Reference 5: JP-A 9-202058

Patent Reference 6: Japanese Patent 3150691

Patent Reference 7: JP-A 6-40171

Patent Reference 8: JP-A 64-1589

### SUMMARY OF THE INVENTION

However, it has been known that the methods described in the above-mentioned patent references are ineffective when the amount added of the additive is small, but when the amount thereof is increased so as to enhance the effect, then there occur other various problems in that the thermal transfer sheets may be much more wrinkled or the dye may bleed out in the surface of the dye layer to cause stains in prints. As a result of such drawbacks, the sheets being processed fuse or adhere together to cause printing failure.

Accordingly, a lubricant is desired, which may solve the problem of printing failure to be caused by fusion and adhesion of sheets, not bringing about the problems of wrinkling of thermal transfer sheets and bleeding out of dyes. The present invention has been made in consideration of the above-mentioned problems, and its object is to provide a thermal transfer sheet and an image formation method capable of solving the problem of printing failure to be caused by fusion and adhesion of thermal transfer sheets and thermal transfer image-receiving sheets, not bringing about wrinkling of sheets and bleeding out of dyes.

The present inventors have assiduously studied for the purpose of attaining the above-mentioned object and, as a result, have found that when a thermal transfer sheet is made to contain a specific polymer having a specific fluoroalkyl group and a specific aliphatic group, then the above-mentioned problems can be solved. The detailed mechanism is not as yet clarified; however, it is presumed that, owing to the function of the fluoroalkyl group-having monomer component that contains fluorine of high surface localizability, the functional group of the second comonomer that has an aliphatic group having a bridging linkage and having at least 7 carbon atoms could also be oriented in the surface of a thermal transfer sheet, therefore favorably improving the surface characteristics of the sheet. The aliphatic group having a bridging linkage and having at least 7 carbon atoms is three-dimensionally bulky, and its affinity for the ink sheet binder is relatively low, and therefore, it is presumed that the functional group may be readily oriented in the surface, and in addition, since the group is highly oleophilic, it may impart high oleophilicity to the surface, therefore capable of favorably improving the surface characteristics of the thermal transfer sheet.

Specifically, the above-mentioned object can be attained by the following means.

(1) A thermal transfer sheet having, as provided on a support, a dye layer containing a thermo-transferable dye in a binder resin, wherein the dye layer contains at least one polymer containing a repetitive unit derived from (a) a monomer of the following formula (1) and (b) a monomer having an aliphatic group that has a bridging linkage and has at least 7 carbon atoms:

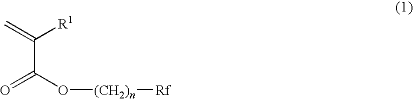

In formula (1), Rf represents substituent containing a fluoroalkyl group having at least 8 fluorine atoms or a perfluoroalkyl group having at least 8 fluorine atoms; n indicates 1 or 2; R¹ represents a hydrogen atom or a methyl group.

(2) The thermal transfer sheet of (1), wherein the dye layer comprises three dye layers of yellow, magenta and cyan, as formed in a frame sequential mode on the support.

(3) The thermal transfer sheet of (1) or (2), wherein at least one transferable protective layer laminate is formed in a frame sequential mode relative to the dye layer.

(4) The thermal transfer sheet of any one of (1) to (3), wherein the binder resin in the dye layer is represented by the following formula (2):

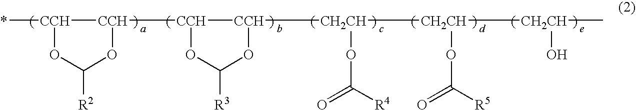

In formula (2), R² to R⁵ each independently represent a substituted or unsubstituted alkyl group having from 1 to 10 carbon atoms, or a substituted or unsubstituted aryl group; a to e each indicate the blend ratio by mass of the constitutive repetitive units; the total of a to e is 100, a and b are independently from 0 to 100, c and d are independently from 0 to 50, e is from 0 to 50, and the total of a and b is from 20 to 100.

(5) The thermal transfer sheet of any one of (1) to (4), which has a back layer on the side of the support opposite to the side thereof having the dye layer.

(6) An image formation method comprising placing the thermal transfer sheet of any one of (1) to (5) and a thermal transfer image-receiving sheet one upon another in such a manner that the dye layer of the former may face the image-receiving layer of the latter, and imparting thermal energy thereto from a thermal head in accordance with an image signal for image formation on the image receiving sheet.

The invention can improve continuous printing durability and may provide images free from printing failure. Concretely, the invention provides a thermal transfer sheet and an image formation method capable of solving a problem of printing failure to be caused by fusion or adhesion of thermal transfer sheets and thermal transfer image-receiving sheets not inducing sheet wrinkling and dye bleeding.

### MODES FOR CARRYING OUT THE INVENTION

The invention is described in detail hereinunder.

### <Thermal Transfer Sheet>

The thermal transfer sheet (ink sheet) to be combined with the above-mentioned thermal transfer image-receiving sheet in thermal transfer image formation comprises, as provided on one surface of a support, a dye layer containing a diffusive transfer dye (this may be referred to as a colorant layer or an ink layer). Preferably, a back layer is formed on the other surface of the support. Also preferably, a transferable protective layer laminate is formed on the same support, having the function of forming, through thermal transfer, a protective layer of a transparent resin on the thermally-transferred image to cover the image for protection.

### [Dye Layer]

### (Specific Polymer)

At least one dye layer of the thermal transfer sheet of the invention contains a polymer derived from (a) a monomer of the above formula (1) and (b) a monomer having an aliphatic group that has a bridging linkage and has at least 7 carbon atoms (hereinafter referred to as “specific polymer”). As containing the specific polymer, the thermal transfer sheet is effective for preventing the printing failure in the thermal transfer image-receiving sheet combined with it.

The specific polymer is a polymer (copolymer) derived from (a) a monomer of the above formula (1) and (b) a monomer having an aliphatic group that has a bridging linkage and has at least 7 carbon atoms. In the invention, the specific polymer tends to localize in the surface of the sheet owing to the function of the fluorine-containing monomer component of the above formula (1). Accordingly, the peeling force between the ink sheet and the image-receiving sheet in transfer can lower, and the printing failure can be thereby prevented.

The copolymerization components, the monomer (a) of the following formula (1) and the monomer (b) having an aliphatic group that has abridging linkage and has at least 7 carbon atoms, which give favorable characteristics to the specific polymer in the invention are described in detail hereinunder.

### (Copolymerization Component (a))

The fluorine-containing monomer used as the copolymerization component (a) in the invention is represented by the following formula (1):

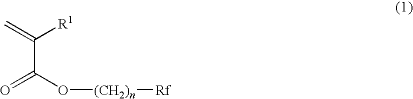

In formula (1), Rf represents substituent containing a fluoroalkyl group having at least 8 fluorine atoms or a perfluoroalkyl group having at least 8 fluorine atoms; n indicates 1 or 2; R¹ represents a hydrogen atom or a methyl group.

The fluorine atom-containing substituent for Rf is a substituent having, as a partial structure thereof, a fluoroalkyl group or a perfluoroalkyl group having at least 8 fluorine atoms.

Concretely mentioned are (per)fluoro(meth)acrylates mentioned below.

CH₂═CRCO₂(CH₂)ₙCₘF₂ₘ₊₁

n indicates 1 or 2; m indicates an integer of from 4 to 12. R represents a hydrogen atom or a methyl group.

CH₂═CRCO₂(CH₂)ₙ(CF₂)ₚH

n indicates 1 or 2; p indicates an integer of from 4 to 12. R represents a hydrogen atom or a methyl group.

In this, the fluoroalkyl group or the perfluoroalkyl group of Rf has at least 8 fluorine atoms; and as using it, a recording layer can be formed, having a fluorine atom concentration distribution in the thickness direction. Regarding its phenomenon, the concentration distribution is such that the fluorine concentration in and around the surface of the recording layer is high and the fluorine concentration lowers in the direction of the depth of the recording layer. As a result, not only the copolymerization component (a) but also all the specific polymer containing the copolymerization component (b) can be favorably localized in and around the surface of the dye layer. In particular, the number of the constitutive fluorine atoms per one monomer unit is preferably from 8 to 30, more preferably from 12 to 25. Within the range, the specific copolymer may exhibit its effect of specifically localizing it in the surface of the layer, therefore giving excellent images. In case where the number of the constitutive fluorine atoms in one unit is at most 30, it is favorable not giving coating failure to be caused by the oil repellency of the fluorine atoms.

### (Copolymerization Component (b))

The monomer to be used as the copolymerization component (b) in the invention is a monomer having a bridged ring that has a bridging linkage and has at least 7 carbon atoms (preferably, a bridged cyclic hydrocarbon group). The bridging linkage is a linkage to bridge in one ring, for example, like in camphor (see Kyoritsu Publishing, Encyclopaedia Chimica 2). It is presumed that, since the aliphatic group having such a bridging linkage exists in and around the surface of the ink sheet, the surface may have high oleophilicity and may therefor contribute toward prevention of printing failure. As compared with the others not having a bridging linkage, the functional group is bulky and, in addition, it has many constitutive carbon atoms in the structure thereof, and therefore, it is considered that the group may have low affinity to the ink sheet binder and may be oriented more in the surface, therefore giving excellent oleophilicity to the sheet.

Regarding the monomer having an aliphatic group that has abridging linkage and has at least 7 carbon atoms, for example, herein mentioned are monomers having similar structures and exemplified in JP-A 2002-311577.

The skeleton of the monomer for use as the copolymerization component (b) includes acrylates, alkylacrylates such as methacrylate; acrylamides, alkylacrylamides such as methacrylamide; styrene derivatives; vinyl esters. Of those, preferred are acrylates, methacrylates, acrylamides and methacrylamides; and more preferred are acrylates and methacrylates.

Specific examples ((b-1) to (b-22)) of the monomer (b) favorable for use in the invention are shown below, to which, however, the invention should not be limited.

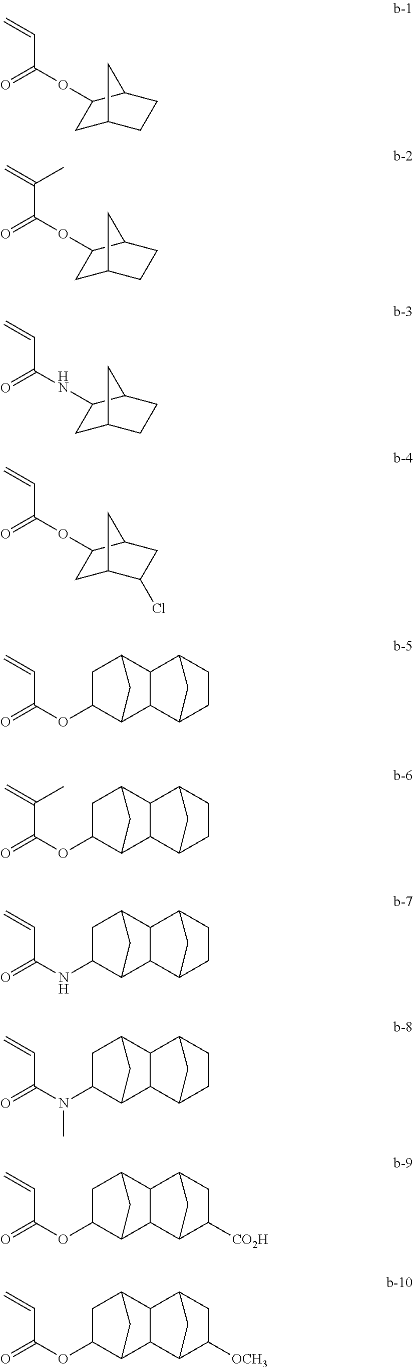

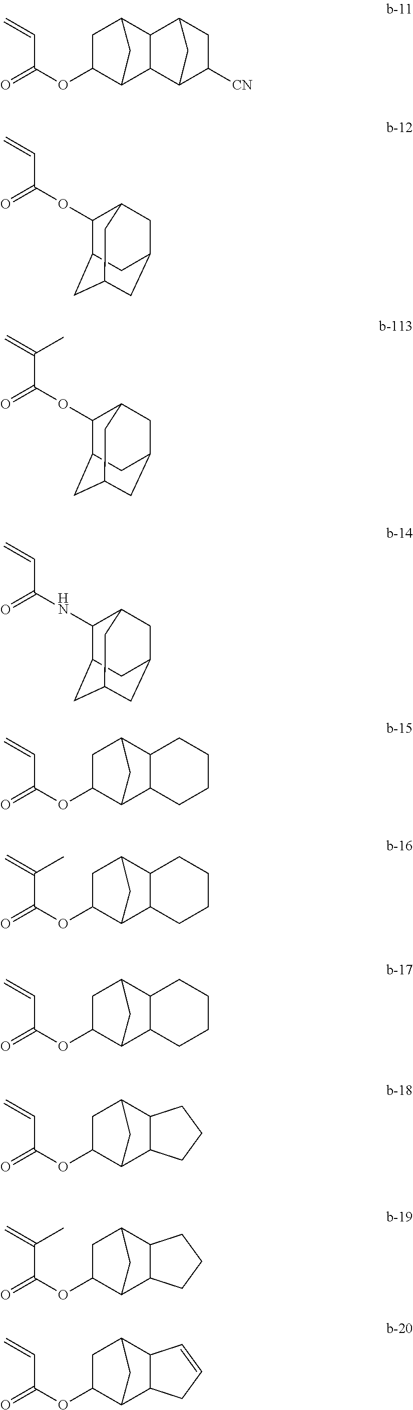

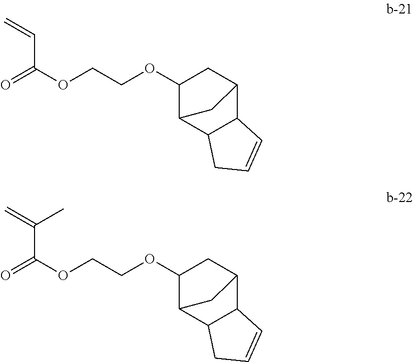

### (Other Copolymerization Components)

The specific polymer for use in the invention may be copolymerized with any other constitutive units than the constitutive units derived from the above-mentioned (a) and (b), for various purposes of coating enhancement or the like within a range not detracting from the effect of the invention.

The other copolymerization components usable herein include those described in Polymer Handbook, 2nd ed., J. Brandrup, Wiley Interscience (1975), Chapter 2, pp. 1-483. For example, there are mentioned constitutive units derived from known monomers such as acrylates, methacrylates, acrylamides, methacrylamides, vinyl esters, styrenes, acrylonitrile, maleic anhydride, maleimide, etc.

The acrylates include, for example, methyl acrylate, ethyl acrylate, (n- or i-)propyl acrylate, (n-, i-, sec- or tert-)butyl acrylate, amyl acrylate, 2-ethylhexyl acrylate, dodecyl acrylate, chloroethyl acrylate, 2-hydroxyethyl acrylate, 2-hydroxypropyl acrylate, 5-hydroxypentyl acrylate, cyclohexyl acrylate, allyl acrylate, trimethylolpropane monoacrylate, pentaerythritol monoacrylate, glycidyl acrylate, benzyl acrylate, methoxybenzyl acrylate, chlorobenzyl acrylate, 2-(p-hydroxyphenyl)ethyl acrylate, furfuryl acrylate, tetrahydrofurfuryl acrylate, phenyl acrylate, chlorophenyl acrylate, sulfamoylphenyl acrylate, etc.

The methacrylates include, for example, methyl methacrylate, ethyl methacrylate, (n- or i-)propyl methacrylate, (n-, i-, sec- or tert-)butyl methacrylate, amyl methacrylate, 2-ethylhexyl methacrylate, dodecyl methacrylate, chloroethyl methacrylate, 2-hydroxyethyl methacrylate, 2-hydroxypropyl methacrylate, 5-hydroxypentyl methacrylate, cyclohexyl methacrylate, allyl methacrylate, trimethylolpropane monomethacrylate, pentaerythritol monomethacrylate, glycidyl methacrylate, methoxybenzyl methacrylate, chlorobenzyl methacrylate, 2-(p-hydroxyphenyl)ethylmethacrylate, furfuryl methacrylate, tetrahydrofurfuryl methacrylate, phenyl methacrylate, chlorophenyl methacrylate, sulfamoylphenyl methacrylate, etc.

The acrylamides include, for example, acrylamide, N-methylacrylamide, N-ethylacrylamide, N-propylacrylamide, N-butylacrylamide, N-benzylacrylamide, N-hydroxyethylacrylamide, N-phenylacrylamide, N-tolylacrylamide, N-(p-hydroxyphenyl)acrylamide, N-(sulfamoylphenyl)acrylamide, N-(phenylsulfonyl)acrylamide, N-(tolylsulfonyl)acrylamide, N,N-dimethylacrylamide, N-methyl-N-phenylacrylamide, N-hydroxyethyl-N-methylacrylamide, etc.

The methacrylamides include, for example, methacrylamide, N-methylmethacrylamide, N-ethylmethacrylamide, N-propylmethacrylamide, N-butylmethacrylamide, N-benzylmethacrylamide, N-hydroxyethylmethacrylamide, N-phenylmethacrylamide, N-tolylmethacrylamide, N-(p-hydroxyphenyl)methacrylamide, N-(sulfamoylphenyl)methacrylamide, N-(phenylsulfonyl)methacrylamide, N-(tolylsulfonyl)methacrylamide, N,N-dimethylmethacrylamide, N-methyl-N-phenylmethacrylamide, N-hydroxyethyl-N-methylmethacrylamide, etc.

The vinyl esters include, for example, vinyl acetate, vinyl butyrate, vinyl benzoate, etc.

The styrenes include, for example, styrene, methylstyrene, dimethylstyrene, trimethylstyrene, ethylstyrene, propylstyrene, cyclohexylstyrene, chloromethylstyrene, trifluoromethylstyrene, ethoxymethylstyrene, acetoxymethylstyrene, methoxystyrene, dimethoxystyrene, chlorostyrene, dichlorostyrene, bromostyrene, iodostyrene, fluorostyrene, carboxystyrene, etc.

Of those co-usable monomers, preferred are acrylates having at most 20 carbon atoms, methacrylates, vinyl esters, styrenes, and acrylonitrile.

In case where the specific polymer in the invention is used, the specific monomer may be used by itself and alone, or may be used along with at least one any other polymer compound having a fluorine-containing substituent but falling outside the scope of the invention as a mixture. The fluorine-containing substituent-having polymer compound that can be used along with the specific polymer may be any commercially-available one, not specifically defined; and concretely, fluorine-containing surfactants and the like generally used in the art are preferably used.

As the specific polymer favorable for use in the invention, mentioned are the following polymer compounds [(P-1) to (P-30)] along with their structure and mass-average molecular weight, to which, however, the invention should not be limited. The values appearing at the right of the chemical formulae are molecular weights (×10,000).

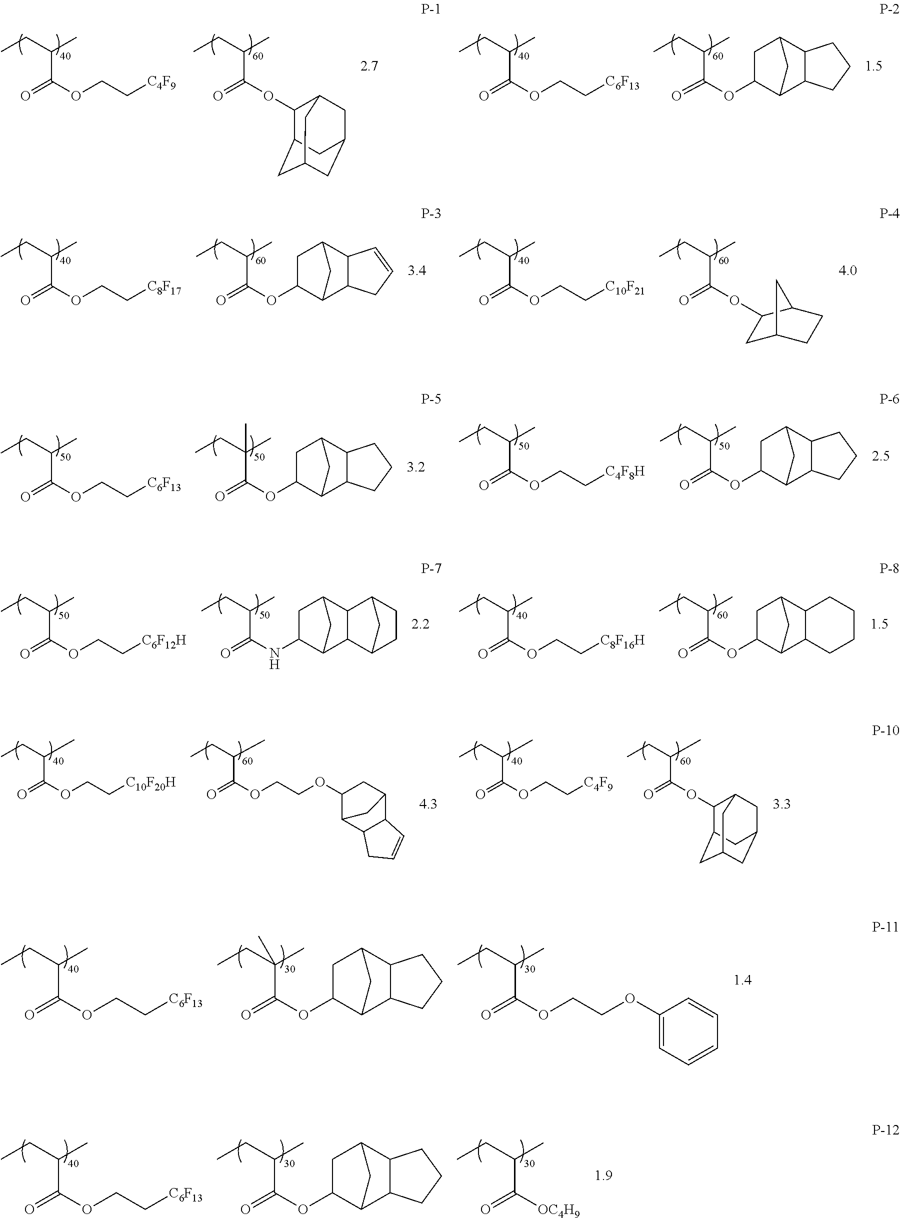

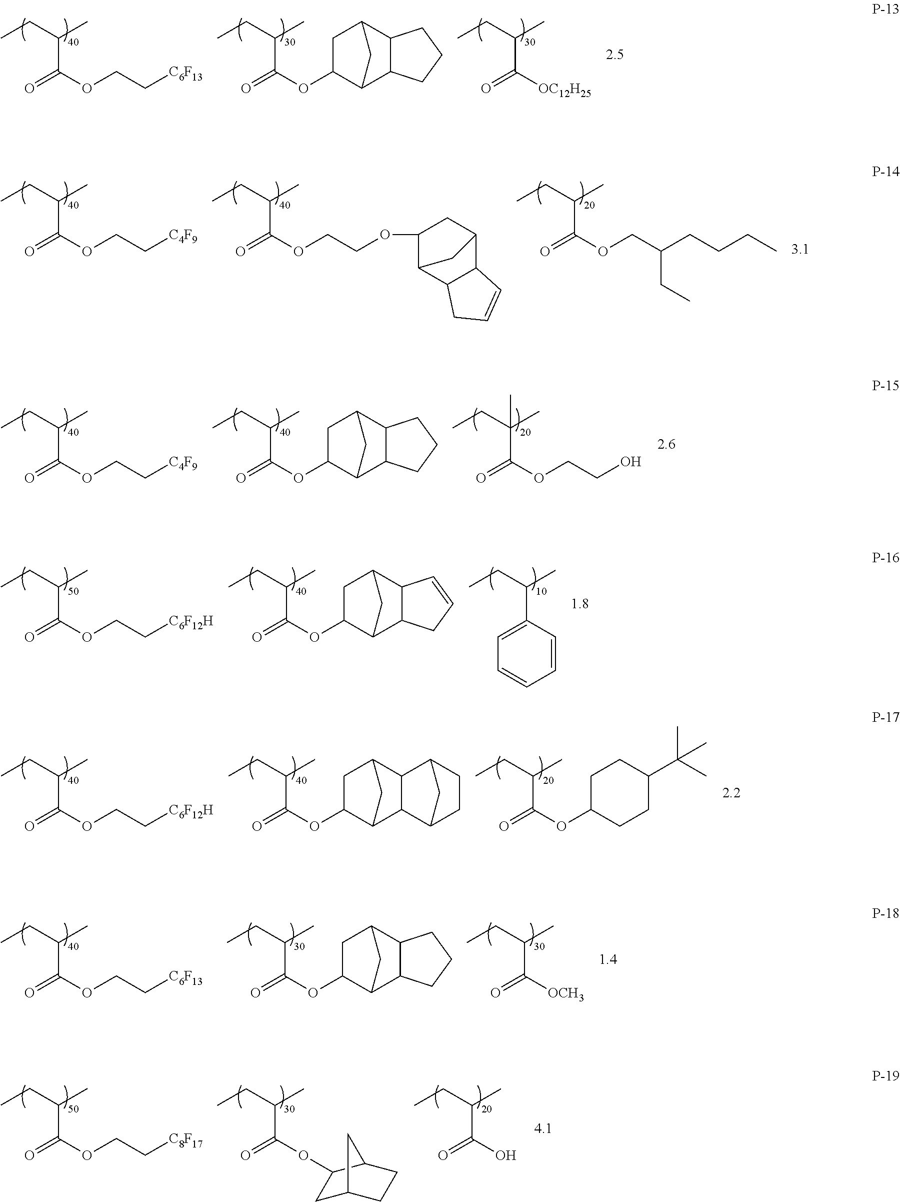

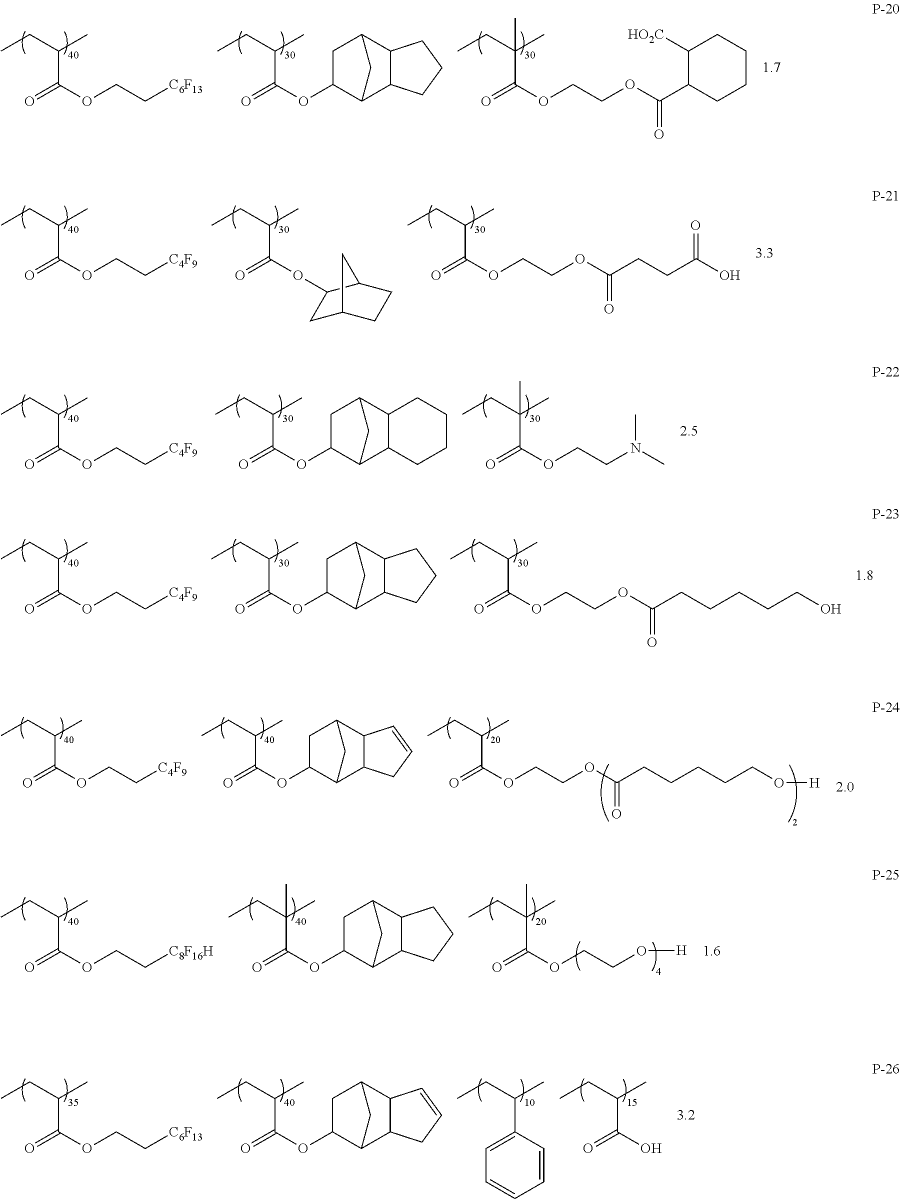

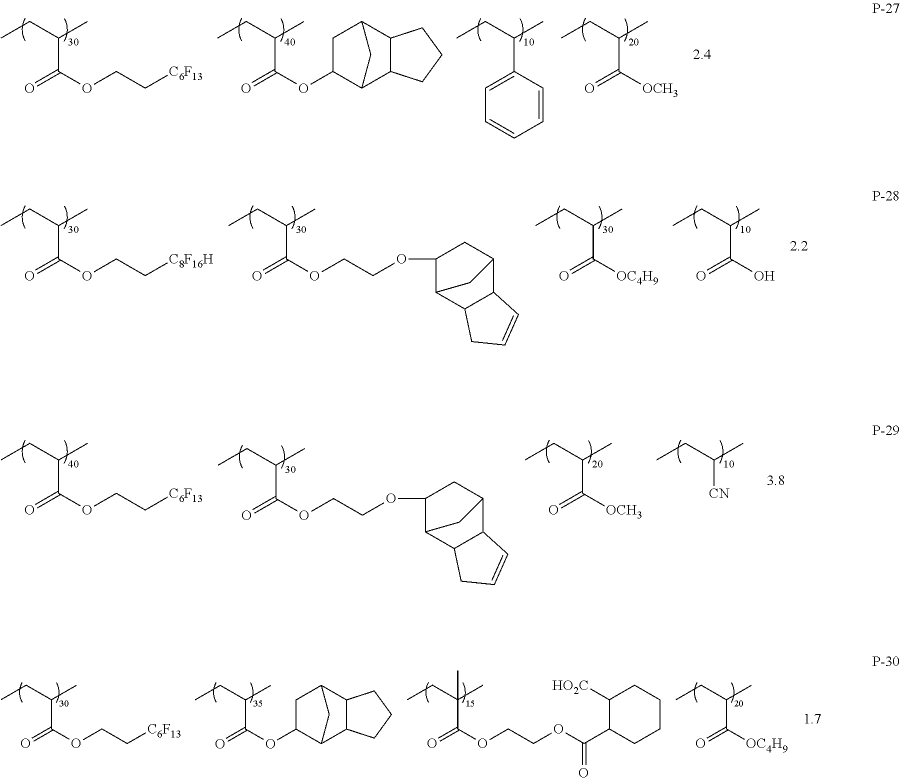

The specific polymer in the invention may be produced in a known conventional manner. For example, the fluorine-containing monomer (a) and the monomer (b) having an aliphatic group that has a bridging linkage and has at least 7 carbon atoms and others, as mentioned in the above, are dissolved in an organic solvent, then an ordinary radical polymerization initiator is added thereto, and the monomers are polymerized to give the intended polymer. As the case may be, any other additional polymerizing unsaturated compound may be added to the above, and may be polymerized in the same manner to give the intended polymer. Depending on the polymerizability of the monomers to be used, employable is a dropping polymerization method of dropping the monomers and the initiator into a reactor for polymerization, and this may be effective for producing a polymer having a uniform composition.

The specific polymer in the invention may be added to any dye layer of yellow, magenta, cyan and optionally black; and may be added to only one dye layer, or to plural dye layers. Preferably, the polymer is in the dye layer of yellow, magenta and cyan.

The amount to be added of the specific polymer in the invention may be suitably determined depending on the type and the amount of the dye and the binder. Preferably, the amount is from 0.01% to 20% relative to the solid content of the dye layer, more preferably from 0.1% to 10%, most preferably from 0.2% to 5%.

### (Constitution of Dye Layer)

The dye layer in the invention contains a thermo-transferable dye and a binder resin. Preferably, individual dye layers of yellow, magenta and cyan and optionally a black dye layer are separately provided on one support according to a frame sequential coating method of repeatedly forming the layers in predetermined sections. As one example, there is mentioned a case of forming dye layers of yellow, magenta and cyan on one support according to a frame sequential coating method of forming them in the major axis direction of the support in accordance with the area of the recording surface of the thermal transfer image-receiving sheet to be combined with the thermal transfer sheet of the invention. In addition to these three layers, either one or both of an additional dye layer of black and a transferable protective layer may be separately provided on the support in predetermined sections; and this embodiment is also preferable.

In such preferred embodiments, it is also desirable to give marks to the thermal transfer sheet for the purpose of transmitting the starting point of each color to printers. In such a mode of repeatedly forming the dye layers in predetermined sections according to the frame sequential coating method, one thermal transfer sheet formed may attain both image formation through dye transfer and lamination of protective layer formation on the image formed.

However, the invention should not be limited to the mode of providing the dye layers as above. A sublimation-type thermo-transferable ink layer and a thermo-fusible transfer ink layer may be provided together on one support; and dye layers of any other color than yellow, magenta, cyan and black may also be provided. The invention includes such modification modes. Regarding the form of the sheet, the thermal transfer sheet of the invention may be in the form of a long continuous sheet or in the form of cut sheets.

The dye layer may have a single-layer constitution or a multi-layer constitution. In the case of multi-layer constitution, the constitutive layers constituting the multi-layered dye layer may have the same or different composition.

The dye ink to form the dye layer contains a dye, preferably a sublimable dye and a binder resin. If desired, it may further contain any of waxes, silicone resins, fluorine-containing organic compounds, etc.

Preferably, the dye layer contains the dye in an amount of from 10 to 90% by mass (of the solid content of the layer), more preferably from 20 to 80% by mass.

The dye layer may be formed by an ordinary coating method of roll coating, bar coating, gravure coating, gravure reverse coating or the like. The coating amount of the dye is preferably from 0.1 to 2.0 g/m² (as solid content—unless otherwise specifically indicated in this description, the coating amount is in term of the solid content of the coating layer), more preferably from 0.2 to 1.2 g/m². The thickness of the dye layer is preferably from 0.1 to 2.0 μm, more preferably from 0.2 to 1.2 μm.

### (Dye)

Not specifically defined, the dye for use in the invention may be any one capable of diffusing by heating, capable of being incorporated into a thermal transfer sheet and capable of being transferred by heating from the thermal transfer sheet to an image-receiving sheet, and may be any dye heretofore used for thermal transfer sheets, or may also be any known dye.

Preferred dyes for use herein are, for example, diarylmethane dyes; triarylmethane dyes; thiazole dyes; methine dyes such as merocyanine; azomethine dyes such as typically indaniline, acetophenonazomethine, pyrazoloazomethine, imidazolazomethine, imidazazomethine, pyridonazomethine; xanthene dyes; oxazine dyes; cyanomethylene dyes such as dicyanostyrene, tricyanostyrene; thiazine dyes, azine dyes; acridine dyes; benzenazo dyes; azo dyes such as pyridonazo dyes, thiophenazo dyes, isothiazolazo dyes, pyrrolazo dyes, pyrazolazo dyes, imidazolazo dyes, thiadiazolazo dyes, triazolazo dyes, disazo dyes; spiropyrane dyes; indolinospiropyrane dyes; fluoran dyes; rhodamine lactam dyes; naphthoquinone dyes; anthraquinone dyes; quinophthalone dyes; etc.

As specific examples, yellow dyes include Disperse Yellow 231, Disperse Yellow 201, Solvent Yellow 93, etc.; magenta dyes include Disperse Violet 26, Disperse Red 60, Solvent red 19, etc.; and cyan dyes include Solvent Blue 63, Solvent Blue 36, Disperse Blue 354, Disperse Blue 35, etc. Needless-to-say, any other suitable dyes than these dyes exemplified herein are also usable in the invention.

Dyes of different colors may be combined in any desired manner for use herein. For example, a black dye may be formed by combination of different dyes.

Colorants (dyes) of formulae (Y1) to (Y9), (M1) to (M8) and (C1) to (C4) favorably used in the invention are described in detail hereinunder.

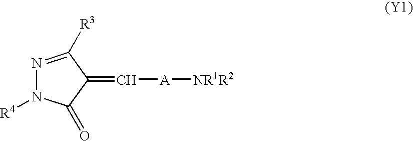

In formula (Y1), A represents a substituted or unsubstituted benzene ring; R¹ and R² each independently represent a hydrogen atom, a substituted or unsubstituted alkyl group, a substituted or unsubstituted alkenyl group, or a substituted or unsubstituted aryl group; R³ represents a hydrogen atom, a substituted or unsubstituted alkyl group, a substituted or unsubstituted amino group, a substituted or unsubstituted alkoxy group, a substituted or unsubstituted aryloxy group, a substituted or unsubstituted alkoxycarbonyl group, a substituted or unsubstituted aryloxycarbonyl group, a substituted or unsubstituted aryl group, or a substituted or unsubstituted carbamoyl group; R⁴ represents a substituted or unsubstituted alkyl group, or a substituted or unsubstituted aryl group.

The substituent with which the group of the above-mentioned A, R¹, R², R³ and R⁴ may be substituted includes a halogen atom, an unsaturated aliphatic group, an aryl group, a heterocyclic group, an aliphatic oxy group (typically an alkoxy group), an acyloxy group, a carbamoyloxy group, an aliphatic oxycarbonyloxy group (typically an alkoxycarbonyloxy group), an aryloxycarbonyloxy group, an amino group, an acylamino group, an aminocarbonylamino group, an aliphatic oxycarbonylamino group (typically an alkoxycarbonylamino group), a sulfamoylamino group, an aliphatic (typically alkyl) or arylsulfonylamino group, an aliphatic thio group (typically an alkylthio group), a sulfamoyl group, an aliphatic (typically alkyl) or arylsulfinyl group, an aliphatic (typically alkyl) or arylsulfonyl group, an acyl group, an aryloxycarbonyl group, an aliphatic oxycarbonyl group (typically an alkoxycarbonyl group), a carbamoyl group, an aryl or heterocyclic azo group, an imido group, a hydroxyl group, a cyano group, a nitro group, a sulfo group, a carboxyl group, etc.

These groups may be further substituted, and the substituent for them may include the above-mentioned ones.

Preferred combinations of the substituents in the dyes of formula (Y1) are as follows: A is a substituted or unsubstituted benzene ring, R′ is a substituted or unsubstituted alkyl group having from 1 to 8 carbon atoms, an allyl group, or a substituted or unsubstituted aryl group having from 6 to 10 carbon atoms; R² is a substituted or unsubstituted alkyl group having from 1 to 8 carbon atoms, an allyl group, or a substituted or unsubstituted aryl group having from 6 to 10 carbon atoms; R³ is a substituted or unsubstituted amino group, or a substituted or unsubstituted alkoxy group; R⁴ is a substituted or unsubstituted alkyl group having from 1 to 8 carbon atoms, or a substituted or unsubstituted aryl group having from 6 to 10 carbon atoms.

More preferred combinations are as follows: A is a substituted or unsubstituted benzene ring, R¹ is a substituted or unsubstituted alkyl group having from 1 to 6 carbon atoms, an allyl group, or a substituted or unsubstituted phenyl group; R² is a substituted or unsubstituted alkyl group having from 1 to 6 carbon atoms, an allyl group, or a substituted or unsubstituted phenyl group; R³ is a substituted or unsubstituted amino group, or a substituted or unsubstituted alkoxy group; R⁴ is a substituted or unsubstituted alkyl group having from 1 to 6 carbon atoms, or a substituted or unsubstituted phenyl group.

Most preferred combinations are as follows: A is a benzene ring substituted with a methyl group or a chlorine atom, or an unsubstituted benzene ring, R¹ is a substituted or unsubstituted alkyl group having from 1 to 4 carbon atoms, or an allyl group; R² is a substituted or unsubstituted alkyl group having from 1 to 4 carbon atoms, or an allyl group; R³ is a substituted or unsubstituted amino group, or a substituted or unsubstituted alkoxy group; R⁴ is a substituted or unsubstituted phenyl group.

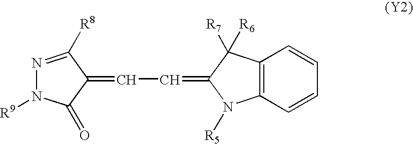

In formula (Y2), R⁵ represents a substituted or unsubstituted alkyl group, or a substituted or unsubstituted alkenyl group; R⁶ and R⁷ each independently represent a substituted or unsubstituted alkyl group; R⁸ represents a substituted or unsubstituted alkyl group, a substituted or unsubstituted aryl group, a substituted or unsubstituted alkoxy group, or a substituted or unsubstituted amino group; R⁹ represents a substituted or unsubstituted alkyl group, or a substituted or unsubstituted aryl group.

The groups of R⁵, R⁶, R⁷, R⁸ and R⁹ may be further substituted. The substituent with which the groups of R⁵, R⁶, R⁷, R⁸ and R⁹ may be substituted may include the same as those for the groups of A, R¹, R², R³ and R⁴ in formula (Y1).

Preferred combinations of the substituents in the dyes of formula (Y2) are as follows: R⁵ is a substituted or unsubstituted alkyl group having from 1 to 8 carbon atoms, or an allyl group; R⁶ is a substituted or unsubstituted alkyl group having from 1 to 8 carbon atoms; R⁷ is a substituted or unsubstituted alkyl group having from 1 to 8 carbon atoms; R⁸ is a substituted or unsubstituted alkyl group having from 1 to 8 carbon atoms, a substituted or unsubstituted aryl group having from 6 to 10 carbon atoms, a substituted or unsubstituted alkoxy group, or a substituted or unsubstituted amino group; R⁹ is a substituted or unsubstituted alkyl group having from 1 to 8 carbon atoms, or a substituted or unsubstituted aryl group having from 6 to 10 carbon atoms.

More preferred combinations are as follows: R⁵ is a substituted or unsubstituted alkyl group having from 1 to 6 carbon atoms, or an allyl group; R⁶ is a substituted or unsubstituted alkyl group having from 1 to 6 carbon atoms; R⁷ is a substituted or unsubstituted alkyl group having from 1 to 6 carbon atoms; R⁸ is a substituted or unsubstituted alkyl group having from 1 to 6 carbon atoms, a substituted or unsubstituted phenyl group, a substituted or unsubstituted alkoxy group, or a substituted or unsubstituted amino group; R⁹ is a substituted or unsubstituted alkyl group having from 1 to 6 carbon atoms, or a substituted or unsubstituted phenyl group.

Most preferred combinations are as follows: R⁵ is a substituted or unsubstituted alkyl group having from 1 to 4 carbon atoms; R⁶ is a substituted or unsubstituted alkyl group having from 1 to 4 carbon atoms; R⁷ is a substituted or unsubstituted alkyl group having from 1 to 4 carbon atoms; R⁸ is a methoxy group, an ethoxy group, or a dimethylamino group; R⁹ is an unsubstituted phenyl group.

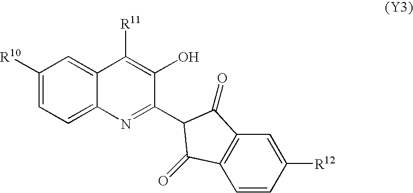

In formula (Y3), R¹⁰ represents a hydrogen atom, or a substituted or unsubstituted alkyl group; R¹¹ represents a hydrogen atom, or a halogen atom; R¹² represents a substituted or unsubstituted alkoxycarbonyl group, a substituted or unsubstituted aryloxycarbonyl group, or a substituted or unsubstituted carbamoyl group.

The groups of R¹⁰ and R¹² may be further substituted. The substituent with which the groups of R¹⁰ and R¹² may be substituted may include the same as those for the groups of A, R¹, R², R³ and R⁴ in formula (Y1).

Preferred combinations of the substituents in the dyes of formula (Y3) are as follows: R¹⁰ is a hydrogen atom, or a substituted or unsubstituted alkyl group having from 1 to 8 carbon atoms; R¹¹ is a hydrogen atom, a chlorine atom, or a bromine atom; R¹² is a substituted or unsubstituted alkoxycarbonyl group, a substituted or unsubstituted aryloxycarbonyl group, or a substituted or unsubstituted carbamoyl group.

More preferred combinations are as follows: R¹⁰ is a hydrogen atom, or a substituted or unsubstituted alkyl group having from 1 to 6 carbon atoms; R¹¹ is a hydrogen atom, or a bromine atom; R¹² is a substituted or unsubstituted alkoxycarbonyl group having from 2 to 10 carbon atoms, or a dialkylcarbamoyl group having from 2 to 12 carbon atoms.

Most preferred combinations are as follows: R¹⁰ is a hydrogen atom, an unsubstituted alkyl group having from 2 to 4 carbon atoms; R¹¹ is a hydrogen atom; R¹² is a dialkylcarbamoyl group having from 2 to 10 carbon atoms.

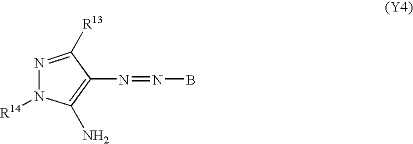

In formula (Y4), B represents a substituted or unsubstituted aryl group, or a substituted or unsubstituted aromatic heterocyclic group; R¹³ represents a substituted or unsubstituted alkyl group; R¹⁴ represents a substituted or unsubstituted alkyl group, or a substituted or unsubstituted aryl group.

The groups of B, R¹³ and R¹⁴ may be further substituted. The substituent with which the groups of B, R¹³ and R¹⁴ may be substituted may include the same as those for the groups of A, R¹, R², R³ and R⁴ in formula (Y1).

Preferred combinations of the substituents in the dyes of formula (Y4) are as follows: B is a substituted or unsubstituted aryl group having from 6 to 10 carbon atoms, a substituted or unsubstituted pyrazolyl group, or a substituted or unsubstituted thiadiazolyl group; R¹³ is a substituted or unsubstituted alkyl group having from 1 to 8 carbon atoms; R¹⁴ is a substituted or unsubstituted alkyl group having from 1 to 8 carbon atoms, or a substituted or unsubstituted aryl group having from 6 to 10 carbon atoms.

More preferred combinations are as follows: B is a substituted or unsubstituted phenyl group, or a substituted or unsubstituted 1,3,4-thiadiazolyl group; R¹³ is a substituted or unsubstituted alkyl group having from 1 to 6 carbon atoms; R¹⁴ is a substituted or unsubstituted alkyl group having from 1 to 6 carbon atoms, or a substituted or unsubstituted phenyl group.

Most preferred combinations are as follows: B is a 4-nitrophenyl group, a 1,3,4-thiadiazolyl group substituted with a thioalkyl group having from 1 to 6 carbon atoms; R¹³ is an unsubstituted alkyl group having from 1 to 4 carbon atoms; R¹⁴ is an unsubstituted alkyl group having from 1 to 4 carbon atoms, or a substituted or unsubstituted phenyl group.

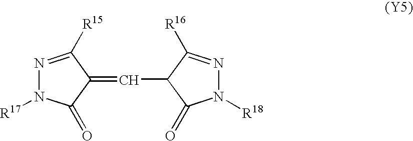

In formula (Y5), R¹⁵, R¹⁶, R¹⁷ and R¹⁸ each independently represent a substituted or unsubstituted alkyl group, or a substituted or unsubstituted aryl group.

The groups of R¹⁵, R¹⁶, R¹⁷ and R¹⁸ may be further substituted. The substituent with which the groups of R¹⁵, R¹⁶, R¹⁷ and R¹⁸ may be substituted may include the same as those for the groups of A, R¹, R², R³ and R⁴ in formula (Y1).

Preferred combinations of the substituents in the dyes of formula (Y5) are as follows: R¹⁵ is a substituted or unsubstituted alkyl group having from 1 to 8 carbon atoms, or a substituted or unsubstituted aryl group having from 6 to 10 carbon atoms; R¹⁶ is a substituted or unsubstituted alkyl group having from 1 to 8 carbon atoms, or a substituted or unsubstituted aryl group having from 6 to 10 carbon atoms; R¹⁷ is a substituted or unsubstituted alkyl group having from 1 to 8 carbon atoms, or a substituted or unsubstituted aryl group having from 6 to 10 carbon atoms; R¹⁸ is a substituted or unsubstituted alkyl group having from 1 to 8 carbon atoms, or a substituted or unsubstituted aryl group having from 6 to 10 carbon atoms.

More preferred combinations are as follows: R¹⁵ is a substituted or unsubstituted alkyl group having from 1 to 6 carbon atoms; R¹⁶ is a substituted or unsubstituted alkyl group having from 1 to 6 carbon atoms; R¹⁷ is a substituted or unsubstituted phenyl group; R¹⁸ is a substituted or unsubstituted phenyl group.

Most preferred combinations are as follows: R¹⁵ is a substituted or unsubstituted alkyl group having from 1 to 4 carbon atoms; R¹⁶ is a substituted or unsubstituted alkyl group having from 1 to 4 carbon atoms; R¹⁷ is a substituted or unsubstituted phenyl group; R¹⁸ is a substituted or unsubstituted phenyl group.

C∫N═N∫D-N═N-E (Y6)

In formula (Y6), C, D and E each independently represent a substituted or unsubstituted benzene ring.

The groups of C, D and E may be further substituted. The substituent with which the groups of C, D and E may be substituted may include the same as those for the groups of A, R¹, R², R³ and R⁴ in formula (Y1).

C is preferably a benzene ring substituted with an alkyl group having from 1 to 8 carbon atoms, a benzene ring substituted with an alkoxy group having from 1 to 8 carbon atoms, a benzene ring substituted with a hydroxyl group, or an unsubstituted benzene ring; more preferably a benzene ring substituted with an alkyl group having from 1 to 6 carbon atoms, a benzene ring substituted with an alkoxy group having from 1 to 6 carbon atoms, or a benzene ring substituted with a hydroxyl group; most preferably a benzene ring substituted with an alkyl group having from 1 to 4 carbon atoms, or a benzene ring substituted with an alkoxy group having from 1 to 4 carbon atoms.

D is preferably a benzene ring substituted with an alkyl group having from 1 to 8 carbon atoms, or an unsubstituted benzene ring; more preferably a benzene ring substituted with an alkyl group having from 1 to 6 carbon atoms, or an unsubstituted benzene ring; most preferably a benzene ring substituted with an alkyl group having from 1 to 4 carbon atoms, or an unsubstituted benzene ring.

E is preferably a benzene ring substituted with a hydroxyl group and an alkyl group having from 1 to 8 carbon atoms, or a benzene ring substituted with a hydroxyl group or an alkoxy group having from 1 to 8 carbon atoms; more preferably a benzene ring substituted with a hydroxyl group and an alkyl group having from 1 to 6 carbon atoms, or a benzene ring substituted with a hydroxyl group or an alkoxy group having from 1 to 6 carbon atoms; most preferably a benzene ring substituted with a hydroxyl group and an alkyl group having from 1 to 4 carbon atoms, or a benzene ring substituted with a hydroxyl group or an alkoxy group having from 1 to 4 carbon atoms.

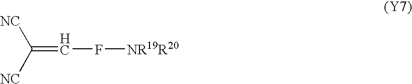

In formula (Y7), F represents a substituted or unsubstituted benzene ring; R¹⁹ and R²⁰ each independently represent a hydrogen atom, a substituted or unsubstituted alkyl group, a substituted or unsubstituted alkenyl group, or a substituted or unsubstituted aryl group.

The groups of F, R¹⁹ and R²⁰ may be further substituted. The substituent with which the groups of F, R¹⁹ and R²⁰ may be substituted may include the same as those for the groups of A, R¹, R², R³ and R⁴ in formula (Y1).

Preferred combinations of the substituents in the dyes of formula (Y7) are as follows: F is a substituted or unsubstituted benzene ring; R¹⁹ is a substituted or unsubstituted alkyl group having from 1 to 8 carbon atoms, an allyl group, or a substituted or unsubstituted aryl group having from 6 to 10 carbon atoms; R²⁰ is a substituted or unsubstituted alkyl group having from 1 to 8 carbon atoms, an allyl group, or a substituted or unsubstituted aryl group having from 6 to 10 carbon atoms.

More preferred combinations are as follows: F is a substituted or unsubstituted benzene ring; R¹⁹ is a substituted or unsubstituted alkyl group having from 1 to 6 carbon atoms, an allyl group, or a substituted or unsubstituted phenyl group; R²⁰ is a substituted or unsubstituted alkyl group having from 1 to 6 carbon atoms, an allyl group, or a substituted or unsubstituted phenyl group.

Most preferred combinations are as follows: F is a benzene ring substituted with a methyl group, R¹⁹ is an unsubstituted alkyl group having from 1 to 4 carbon atoms; R²⁰ is a substituted alkyl group having from 1 to 4 carbon atoms.

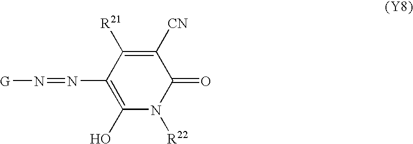

In formula (Y8), G represents a substituted or unsubstituted benzene ring; R²¹ and R²² each independently represent a hydrogen atom, or a substituted or unsubstituted alkyl group.

The groups of G, R²¹ and R²² may be further substituted. The substituent with which the groups of G, R²¹ and R²² may be substituted may include the same as those for the groups of A, R¹, R², R³ and R⁴ in formula (Y1).

Preferred combinations of the substituents in the dyes of formula (Y8) areas follows: G is a substituted benzene ring, R²¹ is a substituted or unsubstituted alkyl group having from 1 to 8 carbon atoms, and R²² is a substituted or unsubstituted alkyl group having from 1 to 8 carbon atoms.

More preferred combinations are as follows: G is a benzene ring substituted with a substituted or unsubstituted alkoxycarbonyl group, R²¹ is a substituted or unsubstituted alkyl group having from 1 to 6 carbon atoms, and R²² is a substituted or unsubstituted alkyl group having from 1 to 6 carbon atoms.

Most preferred combinations are as follows: G is a benzene ring substituted with a substituted or unsubstituted alkoxycarbonyl group, R²¹ is a substituted or unsubstituted alkyl group having from 1 to 4 carbon atoms, and R²² is a substituted or unsubstituted alkyl group having from 1 to 4 carbon atoms.

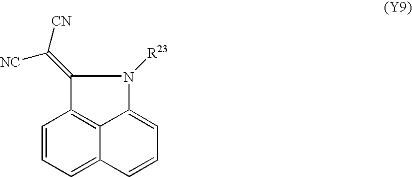

In formula (Y9), R²³ represents a substituted or unsubstituted alkyl group, or a substituted or unsubstituted alkenyl group.

R²³ may be further substituted. The substituent with which the groups of R²³ may be substituted may include the same as those for the groups of A, R¹, R², R³ and R⁴ in formula (Y1).

R²³ is preferably a substituted or unsubstituted alkyl group having from 1 to 8 carbon atoms, or an allyl group; more preferably a substituted or unsubstituted alkyl group having from 1 to 6 carbon atoms, or an allyl group; most preferably a substituted or unsubstituted alkyl group having from 1 to 4 carbon atoms, or an allyl group.

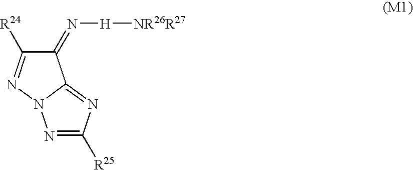

In formula (M1), H represents a substituted or unsubstituted benzene ring, or a substituted or unsubstituted pyridine ring; R²⁴, R²⁵, R²⁶ and R²⁷ each independently represent a substituted or unsubstituted alkyl group, a substituted or unsubstituted alkenyl group, or a substituted or unsubstituted aryl group.

The groups of H, R²⁴, R²⁵, R²⁶ and R²⁷ may be further substituted. The substituent with which the groups of H, R²⁴, R²⁵, R²⁶ and R²⁷ may be substituted may include the same as those for the groups of A, R¹, R², R³ and R⁴ in formula (Y1).

Preferred combinations of the substituents in the dyes of formula (M1) are as follows: H is an unsubstituted benzene ring, R²⁴ is a substituted or unsubstituted alkyl group having from 1 to 8 carbon atoms, or a substituted or unsubstituted aryl group having from 6 to 10 carbon atoms, R²⁵ is a substituted or unsubstituted alkyl group having from 1 to 8 carbon atoms, or a substituted or unsubstituted aryl group having from 6 to 10 carbon atoms, R²⁶ is a substituted or unsubstituted alkyl group having from 1 to 8 carbon atoms, or an allyl group, R²⁷ is a substituted or unsubstituted alkyl group having from 1 to 8 carbon atoms, or an allyl group.

More preferred combinations are as follows: H is an unsubstituted benzene ring, R²⁴ is a substituted or unsubstituted phenyl group, R²⁵ is a substituted or unsubstituted alkyl group having from 1 to 8 carbon atoms, R²⁶ is a substituted or unsubstituted alkyl group having from 1 to 6 carbon atoms, R²⁷ is a substituted or unsubstituted alkyl group having from 1 to 6 carbon atoms.

Most preferred combinations are as follows: H is an unsubstituted benzene ring, R²⁴ is a 2-chlorophenyl group, R²⁵ is a substituted or unsubstituted alkyl group having from 1 to 4 carbon atoms, R²⁶ is a substituted or unsubstituted alkyl group having from 1 to 4 carbon atoms, R²⁷ is a substituted or unsubstituted alkyl group having from 1 to 4 carbon atoms.

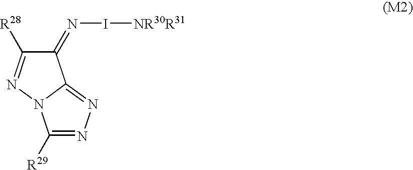

In formula (M2), I represents a substituted or unsubstituted benzene ring, or a substituted or unsubstituted pyridine ring, R²⁸, R²⁹, R³⁰ and R³² each independently represent a substituted or unsubstituted alkyl group, a substituted or unsubstituted alkenyl group, or a substituted or unsubstituted aryl group.

The groups of I, R²⁸, R²⁹, R³⁰ and R³¹ may be further substituted. The substituent with which the groups of I, R²⁸, R²⁹, R³⁰ and R³¹ may be substituted may include the same as those for the groups of A, R¹, R², R³ and R⁴ in formula (Y1).

Preferred combinations of the substituents in the dyes of formula (M2) are as follows: I is a substituted or unsubstituted pyridine ring, or an unsubstituted benzene ring, R²⁸ is a substituted or unsubstituted alkyl group having from 1 to 8 carbon atoms, or a substituted or unsubstituted aryl group having from 6 to 10 carbon atoms, R²⁹ is a substituted or unsubstituted alkyl group having from 1 to 8 carbon atoms, or a substituted or unsubstituted aryl group having from 6 to 10 carbon atoms, R³⁰ is a substituted or unsubstituted alkyl group having from 1 to 8 carbon atoms, or an allyl group, R³² is a substituted or unsubstituted alkyl group having from 1 to 8 carbon atoms, or an allyl group.

More preferred combinations are as follows: I is a substituted or unsubstituted pyridine ring, or an unsubstituted benzene ring, R²⁸ is a substituted or unsubstituted alkyl group having from 1 to 6 carbon atoms, R²⁹ is a substituted or unsubstituted alkyl group having from 1 to 6 carbon atoms, R³⁰ is a substituted or unsubstituted alkyl group having from 1 to 6 carbon atoms, R³² is a substituted or unsubstituted alkyl group having from 1 to 6 carbon atoms.

Most preferred combinations are as follows: I is a substituted or unsubstituted pyridine ring, or an unsubstituted benzene ring, R²⁸ is a substituted or unsubstituted alkyl group having from 1 to 4 carbon atoms, R²⁹ is a substituted or unsubstituted alkyl group having from 1 to 4 carbon atoms, R³⁰ is a substituted or unsubstituted alkyl group having from 1 to 4 carbon atoms, R³¹ is a substituted or unsubstituted alkyl group having from 1 to 4 carbon atoms.

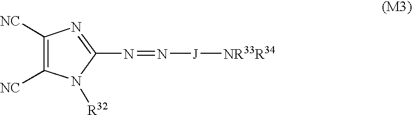

In formula (M3), J represents a substituted or unsubstituted benzene ring, R³², R³³ and R³⁴ each independently represent a substituted or unsubstituted alkyl group, a substituted or unsubstituted alkenyl group, or a substituted or unsubstituted aryl group.

The groups of J, R³², R³³ and R³⁴ may be further substituted. The substituent with which the groups of J, R³², R³³ and R³⁴ may be substituted may include the same as those for the groups of A, R¹, R², R³ and R⁴ in formula (Y1).

Preferred combinations of the substituents in the dyes of formula (M3) are as follows: J is a benzene ring substituted with an acylamino group having from 2 to 8 carbon atoms, R³² is a substituted or unsubstituted alkyl group having from 1 to 8 carbon atoms, or an allyl group, R³³ is a substituted or unsubstituted alkyl group having from 1 to 8 carbon atoms, or an allyl group, R³⁴ is a substituted or unsubstituted alkyl group having from 1 to 8 carbon atoms, or an allyl group.

More preferred combinations are as follows: J is a benzene ring substituted with an acylamino group having from 2 to 6 carbon atoms, R³² is a substituted or unsubstituted alkyl group having from 1 to 6 carbon atoms, or an allyl group, R³³ is a substituted or unsubstituted alkyl group having from 1 to 6 carbon atoms, or an allyl group, R³⁴ is a substituted or unsubstituted alkyl group having from 1 to 6 carbon atoms, or an allyl group.

Most preferred combinations are as follows: J is a benzene ring substituted with an acylamino group having from 2 to 4 carbon atoms, R³² is a substituted or unsubstituted alkyl group having from 1 to 4 carbon atoms, or an allyl group, R³³ is a substituted or unsubstituted alkyl group having from 1 to 4 carbon atoms, or an allyl group, R³⁴ is a substituted or unsubstituted alkyl group having from 1 to 4 carbon atoms, or an allyl group.

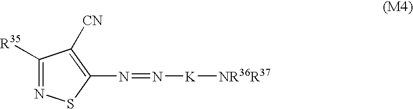

In formula (M4), K represents a substituted or unsubstituted benzene ring, R³⁵, R³⁶ and R³⁷ each independently represent a substituted or unsubstituted alkyl group, a substituted or unsubstituted alkenyl group, or a substituted or unsubstituted aryl group.

The groups of K, R³⁵, R³⁶ and R³⁷ may be further substituted.

The substituent with which the groups of K, R³⁵, R³⁶ and R³⁷ may be substituted may include the same as those for the groups of A, R¹, R², R³ and R⁴ in formula (Y1).

Preferred combinations of the substituents in the dyes of formula (M4) are as follows: K is a benzene ring substituted with an acylamino group having from 2 to 8 carbon atoms, R³⁵ is a substituted or unsubstituted alkyl group having from 1 to 8 carbon atoms, R³⁶ is a substituted or unsubstituted alkyl group having from 1 to 8 carbon atoms, or an allyl group, R³⁷ is a substituted or unsubstituted alkyl group having from 1 to 8 carbon atoms, or an allyl group.

More preferred combinations are as follows: K is a benzene ring substituted with an acylamino group having from 2 to 6 carbon atoms, R³⁵ is a substituted or unsubstituted alkyl group having from 1 to 6 carbon atoms, R³⁶ is a substituted or unsubstituted alkyl group having from 1 to 6 carbon atoms, or an allyl group, R³⁷ is a substituted or unsubstituted alkyl group having from 1 to 6 carbon atoms, or an allyl group.

Most preferred combinations are as follows: K is a benzene ring substituted with an acylamino group having from 2 to 4 carbon atoms, R³⁵ is a substituted or unsubstituted alkyl group having from 1 to 4 carbon atoms, R³⁶ is a substituted or unsubstituted alkyl group having from 1 to 4 carbon atoms, or an allyl group, R³⁷ is a substituted or unsubstituted alkyl group having from 1 to 4 carbon atoms, or an allyl group.

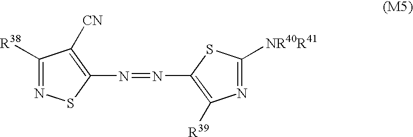

In formula (M5), R³⁸ and R³⁹ each independently represent a substituted or unsubstituted alkyl group, a substituted or unsubstituted aryl group, or a substituted or unsubstituted heterocyclic group, R⁴⁰ and R⁴¹ each independently represent a substituted or unsubstituted alkyl group, a substituted or unsubstituted alkenyl group, or a substituted or unsubstituted aryl group.

The groups of R³⁸, R³⁹, R⁴⁰ and R⁴¹ may be further substituted. The substituent with which the groups of R³⁸, R³⁹, R⁴⁰ and R⁴¹ may be substituted may include the same as those for the groups of A, R¹, R², R³ and R⁴ in formula (Y1).

Preferred combinations of the substituents in the dyes of formula (M5) are as follows: R³⁸ is a substituted or unsubstituted alkyl group having from 1 to 8 carbon atoms, or a substituted or unsubstituted aryl group having from 6 to 10 carbon atoms, R³⁹ is a substituted or unsubstituted alkyl group having from 1 to 8 carbon atoms, or a substituted or unsubstituted aryl group having from 6 to 10 carbon atoms, R⁴⁰ is a substituted or unsubstituted alkyl group having from 1 to 8 carbon atoms, or a substituted or unsubstituted aryl group having from 6 to 10 carbon atoms, R⁴¹ is a substituted or unsubstituted alkyl group having from 1 to 8 carbon atoms, or a substituted or unsubstituted aryl group having from 6 to 10 carbon atoms. More preferred combinations are as follows: R³⁸ is a substituted or unsubstituted alkyl group having from 1 to 6 carbon atoms, or a substituted or unsubstituted phenyl group, R³⁹ is a substituted or unsubstituted alkyl group having from 1 to 6 carbon atoms, or a substituted or unsubstituted phenyl group, R⁴⁰ is a substituted or unsubstituted alkyl group having from 1 to 6 carbon atoms, R⁴¹ is a substituted or unsubstituted alkyl group having from 1 to 6 carbon atoms.

Most preferred combinations are as follows: R³⁸ is a substituted or unsubstituted alkyl group having from 1 to 4 carbon atoms, or a substituted or unsubstituted phenyl group, R³⁹ is a substituted or unsubstituted alkyl group having from 1 to 4 carbon atoms, or a substituted or unsubstituted phenyl group, R⁴⁰ is a substituted or unsubstituted alkyl group having from 1 to 4 carbon atoms, R⁴¹ is a substituted or unsubstituted alkyl group having from 1 to 4 carbon atoms.

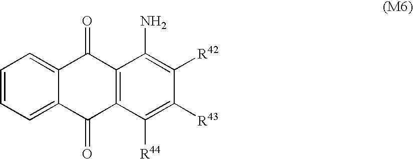

In formula (M6), R⁴² represents a substituted or unsubstituted aryloxy group, R⁴³ represents a hydrogen atom, or a substituted or unsubstituted aryloxy group, R⁴⁴ represents a hydroxyl group, or a substituted or unsubstituted amino group.

The groups of R⁴² and R⁴³ may be further substituted. The substituent with which the groups of R⁴² and R⁴³ may be substituted may include the same as those for the groups of A, R¹, R², R³ and R⁴ in formula (Y1).

Preferred combinations of the substituents in the dyes of formula (M6) are as follows: R⁴² is a substituted or unsubstituted aryloxy group having from 6 to 10 carbon atoms, R⁴³ is a hydrogen atom, or a substituted or unsubstituted aryloxy group having from 6 to 10 carbon atoms, R⁴⁴ is a hydroxyl group, or an unsubstituted amino group.

More preferred combinations are as follows: R⁴² is a substituted or unsubstituted phenoxy group, R⁴³ is a hydrogen atom, or a substituted or unsubstituted phenoxy group, R⁴⁴ is a hydroxyl group, or an unsubstituted amino group.

Most preferred combinations are as follows: R⁴² is a phenoxy group substituted with a substituted or unsubstituted amino group, R⁴³ is a hydrogen atom, or a substituted or unsubstituted phenoxy group, R⁴⁴ is a hydroxyl group, or an unsubstituted amino group.

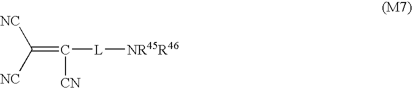

In formula (M7), L represents a substituted or unsubstituted benzene ring, R⁴⁵ and R⁴⁶ each independently represent a hydrogen atom, a substituted or unsubstituted alkyl group, a substituted or unsubstituted alkenyl group, or a substituted or unsubstituted aryl group.

The groups of L, R⁴⁵ and R⁴⁶ may be further substituted. The substituent with which the groups of L, R⁴⁵ and R⁴⁶ may be substituted may include the same as those for the groups of A, R¹, R², R³ and R⁴ in formula (Y1).

Preferred combinations of the substituents in the dyes of formula (M7) are as follows: L is a substituted or unsubstituted benzene ring, R⁴⁵ is a substituted or unsubstituted alkyl group having from 1 to 8 carbon atoms, an allyl group, or a substituted or unsubstituted aryl group having from 6 to 10 carbon atoms, R⁴⁶ is a substituted or unsubstituted alkyl group having from 1 to 8 carbon atoms, an allyl group, or a substituted or unsubstituted aryl group having from 6 to 10 carbon atoms.

More preferred combinations are as follows: L is a substituted or unsubstituted benzene ring, R⁴⁵ is a substituted or unsubstituted alkyl group having from 1 to 6 carbon atoms, an allyl group, or a substituted or unsubstituted phenyl group, R⁴⁶ is a substituted or unsubstituted alkyl group having from 1 to 6 carbon atoms, an allyl group, or a substituted or unsubstituted phenyl group.

Most preferred combinations are as follows: L is a benzene ring substituted with a methyl group, R⁴⁵ is an unsubstituted alkyl group having from 1 to 4 carbon atoms, R⁴⁶ is a substituted alkyl group having from 1 to 4 carbon atoms.

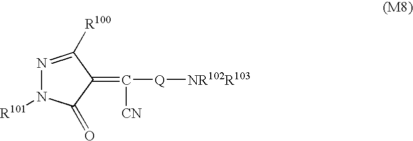

In formula (M8), Q represents a substituted or unsubstituted benzene ring, R¹⁰⁰ represents a substituted or unsubstituted alkyl group, a substituted or unsubstituted aryl group, a substituted or unsubstituted alkoxy group, or a substituted or unsubstituted amino group, R¹⁰¹ represents a substituted or unsubstituted alkyl group, or a substituted or unsubstituted aryl group, R¹⁰² and R¹⁰³ each independently represent a hydrogen atom, a substituted or unsubstituted alkyl group, a substituted or unsubstituted alkenyl group, or a substituted or unsubstituted aryl group.

The groups of Q, R¹⁰⁰, R¹⁰¹, R¹⁰² and R¹⁰³ may be further substituted. The substituent with which the groups of Q, R¹⁰⁰, R¹⁰¹, R¹⁰² and R¹⁰³ may be substituted may include the same as those for the groups of A, R¹, R², R³ and R⁴ in formula (Y1).

Preferred combinations of the substituents in the dyes of formula (M8) are as follows: Q is a substituted or unsubstituted benzene ring, R¹⁰² is a substituted or unsubstituted alkyl group having from 1 to 8 carbon atoms, an allyl group, or a substituted or unsubstituted aryl group having from 6 to 10 carbon atoms, R¹⁰³ is a substituted or unsubstituted alkyl group having from 1 to 8 carbon atoms, an allyl group, or a substituted or unsubstituted aryl group having from 6 to 10 carbon atoms, R¹⁰⁰ is a substituted or unsubstituted amino group, or a substituted or unsubstituted alkoxy group, R¹⁰¹ is a substituted or unsubstituted alkyl group having from 1 to 8 carbon atoms, or a substituted or unsubstituted aryl group having from 6 to 10 carbon atoms.

More preferred combinations are as follows: Q is a substituted or unsubstituted benzene ring, R¹⁰² is a substituted or unsubstituted alkyl group having from 1 to 6 carbon atoms, an allyl group, or a substituted or unsubstituted phenyl group, R¹⁰³ is a substituted or unsubstituted alkyl group having from 1 to 6 carbon atoms, an allyl group, or a substituted or unsubstituted phenyl group, R¹⁰⁰ is a substituted or unsubstituted amino group, or a substituted or unsubstituted alkoxy group, R¹⁰¹ is a substituted or unsubstituted alkyl group having from 1 to 6 carbon atoms, or a substituted or unsubstituted phenyl group.

Most preferred combinations are as follows: Q is a substituted or unsubstituted benzene ring, R¹⁰² is a substituted or unsubstituted alkyl group having from 1 to 4 carbon atoms, or an allyl group, R¹⁰³ is a substituted or unsubstituted alkyl group having from 1 to 4 carbon atoms, or an allyl group, R¹⁰⁰ is a substituted or unsubstituted amino group, or a substituted or unsubstituted alkoxy group, R¹⁰¹ is a substituted or unsubstituted phenyl group.

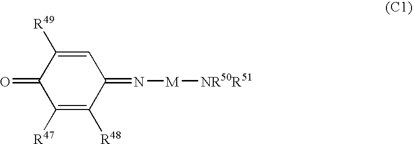

In formula (C1), M represents a substituted or unsubstituted benzene ring, R⁴⁷ represents a hydrogen atom, or a halogen atom, R⁴⁸ represents a substituted or unsubstituted alkyl group, R⁴⁹ represents a substituted or unsubstituted acylamino group, or a substituted or unsubstituted alkoxycarbonylamino group, R⁵⁰ and R⁵¹ each independently represent a substituted or unsubstituted alkyl group, a substituted or unsubstituted alkenyl group, or a substituted or unsubstituted aryl group.

The groups of M, R⁴⁸, R⁴⁹, R⁵⁰ and R⁵¹ may be further substituted. The substituent with which the groups of M, R⁴⁸, R⁴⁹, R⁵⁰ and R⁵¹ may be substituted may include the same as those for the groups of A, R¹, R², R³ and R⁴ in formula (Y1).

Preferred combinations of the substituents in the dyes of formula (C1) are as follows: M is a benzene ring substituted with an alkyl group having from 1 to 4 carbon atoms, a benzene ring substituted with a chlorine atom, or an unsubstituted benzene ring, R⁴⁷ is a hydrogen atom, a chlorine atom, or a bromine atom, R⁴⁸ is a substituted or unsubstituted alkyl group having from 1 to 8 carbon atoms, R⁴⁹ is a substituted or unsubstituted acylamino group having from 2 to 10 carbon atoms, or a substituted or unsubstituted alkoxycarbonylamino group having from 2 to 10 carbon atoms, R⁵⁰ is a substituted or unsubstituted alkyl group having from 1 to 8 carbon atoms, R⁵¹ is a substituted or unsubstituted alkyl group having from 1 to 8 carbon atoms.

More preferred combinations are as follows: M is a benzene ring substituted with an alkyl group having from 1 to 2 carbon atoms, or an unsubstituted benzene ring, R⁴⁷ is a hydrogen atom, or a chlorine atom, R⁴⁸ is a substituted or unsubstituted alkyl group having from 1 to 6 carbon atoms, R⁴⁹ is a substituted or unsubstituted acylamino group having from to 8 carbon atoms, or a substituted or unsubstituted alkoxycarbonylamino group having from 2 to 8 carbon atoms, R⁵⁰ is a substituted or unsubstituted alkyl group having from 1 to 6 carbon atoms, R⁵¹ is a substituted or unsubstituted alkyl group having from 1 to 6 carbon atoms.

Most preferred combinations are as follows: M is a benzene ring substituted with a methyl group, or an unsubstituted benzene ring, R⁴⁷ is a hydrogen atom, or a chlorine atom, R⁴⁸ is a substituted or unsubstituted alkyl group having from 1 to 6 carbon atoms, R⁴⁹ is a substituted or unsubstituted acylamino group having from 2 to 6 carbon atoms, or a substituted or unsubstituted alkoxycarbonylamino group having from 2 to 6 carbon atoms, R⁵⁰ is a substituted or unsubstituted alkyl group having from 1 to 4 carbon atoms, R⁵¹ is a substituted or unsubstituted alkyl group having from 1 to 4 carbon atoms.

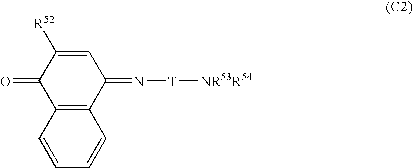

In formula (C2), T represents a substituted or unsubstituted benzene ring, R⁵² represents a hydrogen atom, a substituted or unsubstituted acylamino group, a substituted or unsubstituted alkoxycarbonyl group, or a substituted or unsubstituted carbamoyl group, R⁵³ and R⁵⁴ each independently represent a substituted or unsubstituted alkyl group, a substituted or unsubstituted alkenyl group, or a substituted or unsubstituted aryl group.

The groups of T, R⁵², R⁵³ and R⁵⁴ may be further substituted. The substituent with which the groups of T, R⁵², R⁵³ and R⁵⁴ may be substituted may include the same as those for the groups of A, R¹, R², R³ and R⁴ in formula (Y1).

Preferred combinations of the substituents in the dyes of formula (C2) are as follows: T is a benzene ring substituted with an alkyl group having from 1 to 8 carbon atoms, a benzene ring substituted with an alkoxy group having from 1 to 8 carbon atoms, or an unsubstituted benzene ring, R⁵² is a hydrogen atom, a substituted or unsubstituted acylamino group having from 2 to 10 carbon atoms, a substituted or unsubstituted alkoxycarbonyl group having from 2 to 10 carbon atoms, or a substituted or unsubstituted carbamoyl group having from 1 to 10 carbon atoms, R⁵³ is a substituted or unsubstituted alkyl group having from 1 to 8 carbon atoms, R⁵⁴ is a substituted or unsubstituted alkyl group having from 1 to 8 carbon atoms.

More preferred combinations are as follows: T is a benzene ring substituted with an alkyl group having from 1 to 6 carbon atoms, a benzene ring substituted with an alkoxy group having from 1 to 6 carbon atoms, or an unsubstituted benzene ring, R⁵² is a hydrogen atom, a substituted or unsubstituted acylamino group having from 2 to 8 carbon atoms, a substituted or unsubstituted alkoxycarbonyl group having from 2 to 8 carbon atoms, or a substituted or unsubstituted carbamoyl group having from 1 to 8 carbon atoms, R⁵³ is a substituted or unsubstituted alkyl group having from 1 to 6 carbon atoms, R⁵⁴ is a substituted or unsubstituted alkyl group having from 1 to 6 carbon atoms.

Most preferred combinations are as follows: T is a benzene ring substituted with an alkyl group having from 1 to 4 carbon atoms, a benzene ring substituted with an alkoxy group having from 1 to 4 carbon atoms, or an unsubstituted benzene ring, R⁵² is a hydrogen atom, a substituted or unsubstituted acylamino group having from 2 to 6 carbon atoms, a substituted or unsubstituted alkoxycarbonyl group having from 2 to 6 carbon atoms, or a substituted or unsubstituted carbamoyl group having from 1 to 6 carbon atoms, R⁵³ is a substituted or unsubstituted alkyl group having from 1 to 4 carbon atoms, R⁵⁴ is a substituted or unsubstituted alkyl group having from 1 to 4 carbon atoms.

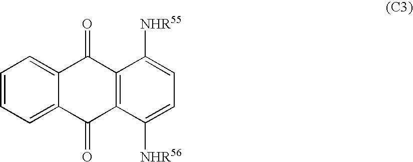

In formula (C3), R⁵⁵ and R⁵⁶ each independently represent a substituted or unsubstituted alkyl group, or a substituted or unsubstituted aryl group.

The groups of R⁵⁵ and R⁵⁶ may be further substituted. The substituent with which the groups of R⁵⁵ and R⁵⁶ may be substituted may include the same as those for the groups of A, R¹, R², R³ and R⁴ in formula (Y1).

Preferred combinations of the substituents in the dyes of formula (C3) are as follows: R⁵⁵ is a substituted or unsubstituted alkyl group having from 1 to 8 carbon atoms, or a substituted or unsubstituted aryl group having from 6 to 10 carbon atoms, R⁵⁶ is a substituted or unsubstituted alkyl group having from 1 to 8 carbon atoms, or a substituted or unsubstituted aryl group having from 6 to 10 carbon atoms.

More preferred combinations are as follows: R⁵⁵ is a substituted or unsubstituted alkyl group having from 1 to 6 carbon atoms, or a substituted or unsubstituted phenyl group, R⁵⁶ is a substituted or unsubstituted alkyl group having from 1 to 6 carbon atoms, or a substituted or unsubstituted phenyl group.

Most preferred combinations are as follows: R⁵⁵ is a substituted or unsubstituted alkyl group having from 1 to 4 carbon atoms, R⁵⁶ is a substituted or unsubstituted alkyl group having from 1 to 4 carbon atoms, or a substituted or unsubstituted phenyl group.

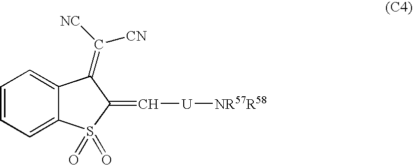

In formula (C4), U represents a substituted or unsubstituted benzene ring, R⁵⁷ and R⁵⁸ each independently represent a substituted or unsubstituted alkyl group, a substituted or unsubstituted alkenyl group, or a substituted or unsubstituted aryl group.

The groups of U, R⁵⁷ and R⁵⁸ may be further substituted. The substituent with which the groups of U, R⁵⁷ and R⁵⁸ may be substituted may include the same as those for the groups of A, R¹, R², R³ and R⁴ in formula (Y1).

Preferred combinations of the substituents in the dyes of formula (C4) are as follows: U is a benzene ring substituted with an alkyl group having from 1 to 8 carbon atoms, a benzene ring substituted with an alkoxy group having from 1 to 8 carbon atoms, or an unsubstituted benzene ring, R⁵⁷ is a substituted or unsubstituted alkyl group having from 1 to 8 carbon atoms, R⁵⁸ is a substituted or unsubstituted alkyl group having from 1 to 8 carbon atoms.

More preferred combinations are as follows: U is a benzene ring substituted with an alkyl group having from 1 to 6 carbon atoms, a benzene ring substituted with an alkoxy group having from 1 to 6 carbon atoms, or an unsubstituted benzene ring, R⁵⁷ is a substituted or unsubstituted alkyl group having from 1 to 6 carbon atoms, R⁵⁸ is a substituted or unsubstituted alkyl group having from 1 to 6 carbon atoms.

Most preferred combinations are as follows: U is a benzene ring substituted with an alkyl group having from 1 to 4 carbon atoms, a benzene ring substituted with an alkoxy group having from 1 to 4 carbon atoms, or an unsubstituted benzene ring, R⁵⁷ is a substituted or unsubstituted alkyl group having from 1 to 4 carbon atoms, R⁵⁸ is a substituted or unsubstituted alkyl group having from 1 to 4 carbon atoms.

Specific examples of dye compounds of formulae (Y1) to (Y9), (M1) to (M8), and (C1) to (C4) preferred for use in the invention are shown below; however, the dyes of formulae (Y1) to (Y9), (M1) to (M8), and (C1) to (C4) for use in the invention should not be limitatively interpreted by these specific examples.

TABLE 1
Dyes of Formula (Y1)

| Com- | | | | | |
|---|---|---|---|---|---|
| pound | | | | | |
| Ex- | | | | | |
| ample | A | R¹ | R² | R³ | R⁴ |
| Y1-1 | 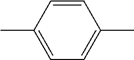 | ethyl | ethyl | ethoxy | phenyl |
| Y1-2 | 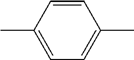 | ethyl | ethyl | dimethyl- amino | phenyl |
| Y1-3 | 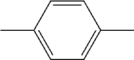 | n- propyl | n- propyl | ethoxy | phenyl |
| Y1-4 | 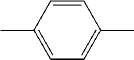 | n- butyl | n- butyl | ethoxy | phenyl |

TABLE 2
Dyes of Formula (Y2)

| Compound | | | | | |
|---|---|---|---|---|---|
| Example | R⁵ | R⁶ | R⁷ | R⁸ | R⁹ |
| Y2-1 | ethyl | methyl | methyl | dimethylamino | phenyl |
| Y2-2 | n-propyl | methyl | methyl | dimethylamino | phenyl |
| Y2-3 | allyl | methyl | methyl | dimethylamino | phenyl |
| Y2-4 | ethyl | methyl | methyl | ethoxy | phenyl |

TABLE 3
Dyes of Formula (Y3)

| Compound | | | |
|---|---|---|---|
| Example | R¹⁰ | R¹¹ | R¹² |
| Y3-1 | isopropyl | hydrogen | di-n-butylcarbamoyl |
| Y3-2 | hydrogen | bromine | di-n-butylcarbamoyl |

TABLE 4
Dyes of Formula (Y4)

| Compound | | | |
|---|---|---|---|
| Example | B | R¹³ | R¹⁴ |
| Y4-1 | 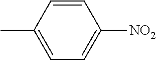 | tert-butyl | phenyl |
| Y4-2 | 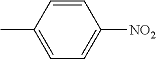 | tert-butyl | methyl |
| Y4-3 | 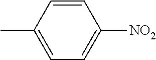 | tert-butyl | 4-(ethoxy- carbonyl)phenyl |

TABLE 5
Dyes of Formula (Y5)

| Compound | | | | |
|---|---|---|---|---|
| Example | R¹⁵ | R¹⁶ | R¹⁷ | R¹⁸ |
| Y5-1 | methyl | methyl | phenyl | phenyl |
| Y5-2 | methyl | methyl | methyl | methyl |

TABLE 6
Dyes of Formula (Y6)

| Compound | | | |
|---|---|---|---|
| Example | C | D | E |
| Y6-1 | 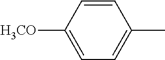 | 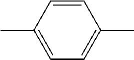 | 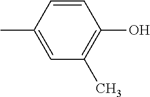 |
| Y6-2 | 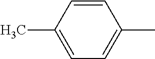 | 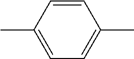 | 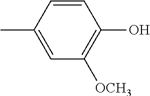 |

TABLE 7
Dyes of Formula (Y7)

| Compound | | | |
|---|---|---|---|
| Example | F | R¹⁹ | R²⁰ |
| Y7-1 | 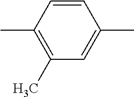 | n-butyl | benzyl |
| Y7-2 | 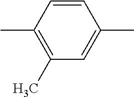 | ethyl | 4-cyclohexylphenoxyethyl |
| Y7-3 | 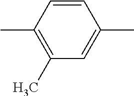 | ethyl | phenethyl |
| Y7-4 | 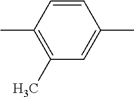 | n-butyl | phenethyl |

TABLE 8
Dyes of Formula (Y8)

| Compound | | | |
|---|---|---|---|
| Example | G | R²¹ | R²² |
| Y8-1 | 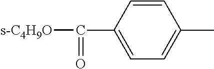 | methyl | s-butyl |
| Y8-2 | 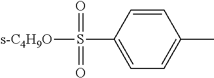 | methyl | tert-pentyl |

TABLE 9
Dyes of Formula (Y9)

| Compound | |
|---|---|
| Example | R²³ |
| Y9-1 | ethyl |
| Y9-2 | n-propyl |
| Y9-3 | n-butyl |

TABLE 10
Dyes of Formula (M1)

| Compound | | | | | |
|---|---|---|---|---|---|
| Example | H | R²⁴ | R²⁵ | R²⁶ | R²⁷ |
| M1-1 | 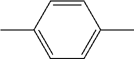 | 2-chloro- phenyl | isopropyl | n-butyl | cyanoethyl |
| M1-2 | 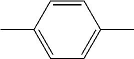 | 2-chloro- phenyl | isopropyl | acetoxy- ethyl | acetoxy- ethyl |
| M1-3 | 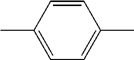 | 2-chloro- phenyl | isopropyl | n-butyl | 4-methoxy- phenoxy- ethyl |

TABLE 11
Dyes of Formula (M2)

| Compound | | | | | |
|---|---|---|---|---|---|
| Example | I | R²⁸ | R²⁹ | R³⁰ | R³¹ |
| M2-1 | 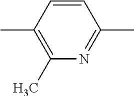 | tert-butyl | 3-methyl- phenyl | ethyl | ethyl |
| M2-2 | 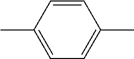 | 2-chloro- phenyl | isopropyl | n-butyl | cyanoethyl |

TABLE 12
Dyes of Formula (M3)

| Compound | | | | |
|---|---|---|---|---|
| Example | J | R³² | R³³ | R³⁴ |
| M3-1 | 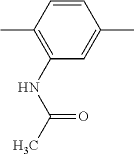 | n-butyl | n-butyl | n-butyl |
| M3-2 | 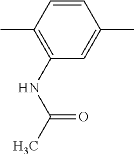 | allyl | n-propyl | n-propyl |

TABLE 13
Dyes of Formula (M4)

| Compound | | | | |
|---|---|---|---|---|
| Example | K | R³⁵ | R³⁶ | R³⁷ |
| M4-1 | 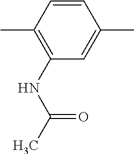 | methyl | ethyl | benzyl |
| M4-2 | 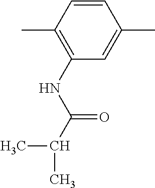 | methyl | ethyl | benzyl |

TABLE 14
Dyes of Formula (M5)

| Compound | | | | |
|---|---|---|---|---|
| Example | R³⁸ | R³⁹ | R⁴⁰ | R⁴¹ |
| M5-1 | methyl | tert-butyl | ethyl | ethyl |
| M5-2 | phenyl | tert-butyl | ethyl | ethyl |
| M5-3 | methyl | tert-butyl | n-propyl | n-propyl |
| M5-4 | methyl | tert-butyl | n-butyl | n-butyl |

TABLE 15
Dyes of Formula (M6)

| Compound | | | |
|---|---|---|---|
| Example | R⁴² | R⁴³ | R⁴⁴ |
| M6-1 | phenoxy | hydrogen | hydroxyl |
| M6-2 | phenoxy | phenoxy | amino |
| M6-3 | m-(N-methylamino)phenyl | hydrogen | hydroxyl |

TABLE 16
Dyes of Formula (M7)

| Compound | | | |
|---|---|---|---|
| Example | L | R⁴⁵ | R⁴⁶ |
| M7-1 | 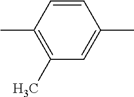 | ethyl | ethyl |
| M7-2 | 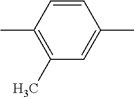 | n-propyl | n-propyl |

TABLE 17
Dyes of Formula (M8)

| Compound | | | | | |
|---|---|---|---|---|---|
| Example | Q | R¹⁰⁰ | R¹⁰¹ | R¹⁰² | R¹⁰³ |
| M8-1 | 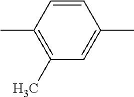 | dimethyl- amino | phenyl | ethyl | ethyl |
| M8-2 | 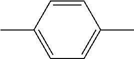 | dimethyl- amino | phenyl | ethyl | ethyl |
| M8-3 | 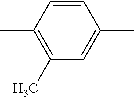 | ethoxy | phenyl | ethyl | ethyl |
| M8-4 | 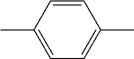 | ethoxy | phenyl | ethyl | ethyl |

TABLE 18
Dyes of Formula (C1)

| Compound | | | | | | |
|---|---|---|---|---|---|---|
| Example | M | R⁴⁷ | R⁴⁸ | R⁴⁹ | R⁵⁰ | R⁵¹ |
| C1-1 | 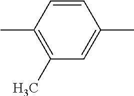 | chlorine | methyl | acetyl- amino | ethyl | ethyl |
| C1-2 | 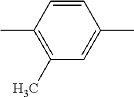 | hydrogen | methyl | acetyl- amino | ethyl | ethyl |
| C1-3 | 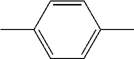 | chlorine | hydrogen | 3-pyrrol- idine- carbonyl- amino | n-propyl | n-propyl |
| C1-4 | 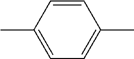 | chlorine | methyl | acetyl- amino | n-propyl | n-propyl |
| C1-5 | 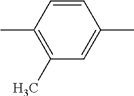 | chlorine | ethyl | 2-furoyl- amino | ethyl | ethyl |

TABLE 19
Dyes of Formula (C2)

| Compound | | | | |
|---|---|---|---|---|
| Example | N | R⁵² | R⁵³ | R⁵⁴ |
| C2-1 | 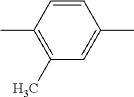 | dimethyl- carbamoyl | ethyl | benzyl |
| C2-2 | 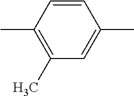 | acetylamino | ethyl | ethyl |
| C2-3 | 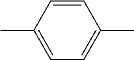 | hydrogen | ethyl | isopropyl |
| C2-4 | 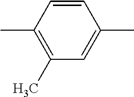 | ethoxycarbonyl | ethyl | ethyl |
| C2-5 | 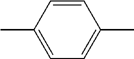 | hydrogen | ethyl | ethyl |

TABLE 20
Dyes of Formula (C3)

| Compound | | |
|---|---|---|
| Example | R⁵⁵ | R⁵⁶ |
| C3-1 | isopropyl | isopropyl |
| C3-2 | methyl | m-toluyl |
| C3-3 | m-toluyl | m-toluyl |

TABLE 21
Dyes of Formula (C4)

| Compound | | |
|---|---|---|
| Example | R⁵⁵ | R⁵⁶ |
| C4-1 | ethyl | ethyl |
| C4-2 | n-propyl | n-propyl |
| C4-3 | n-butyl | n-butyl |

### (Binder Resin)

Various resins are known as the binder resin to be in the dye layer for supporting the above-mentioned dye therein, and they may be used in the invention. For example, herein usable are modified cellulose resins such as ethyl cellulose, hydroxyethyl cellulose, ethyl hydroxycellulose, hydroxypropyl cellulose, ethylhydroxyethyl cellulose, methyl cellulose, cellulose acetate, cellulose acetate butyrate, cellulose acetate propionate, cellulose nitrate; polyvinyl acetals such as polyvinyl alcohol, polyvinyl acetate, polyvinyl acetacetal, polyvinyl butyral; vinyl resins such as polyvinyl pyrrolidone, polystyrene, polyvinyl chloride; acrylic resins such as polyacrylonitrile, polyacrylate, polyacrylamide; polyurethane resins, polyamide resins, polyester resins, polycarbonate resins, phenoxy resins, phenol resins, epoxy resins, various elastomers, etc. Above all, preferred are modified cellulose resins such as typically propionic acid-modified cellulose; and polyvinyl acetals such as typically polyvinyl acetacetal and polyvinyl butyral. These may be used either along or as combined; or in case where these are polymers, they may be copolymerized with various constitutive monomers, or may be crosslinked with various crosslinking agents.

A resin of the following formula (2) is especially preferred for the binder resin.

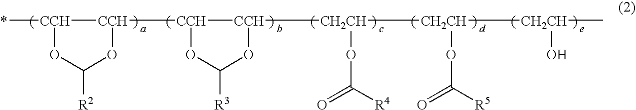

In formula (2), R² to R⁵ each represent a substituted or unsubstituted alkyl group having from 1 to 10 carbon atoms, or a substituted or unsubstituted aryl group.

a to e each indicate the blend ratio by mass of the constitutive repetitive units; the total of a to e is 100, a and b are independently from 0 to 100, c and d are independently from 0 to 50, e is from 0 to 50, and the total of a and b is from 20 to 100.

The total of a and b is preferably from 30 to 95, more preferably from 50 to 95. Preferably, c and d each are from 0 to 30, more preferably from 0 to 20. e is preferably from 0 to 40, more preferably from 0 to 30.

Preferably, the resin of formula (2) has a mass-average molecular weight of from 10,000 to 400,000, more preferably from 80,000 to 300,000.

The resin of formula (2) may be a block copolymer or a random copolymer, and may be produced in any copolymerization method.

As the resin, usable are commercial products, for example, including Denkabutyral #6000-C (trade name by Denki Kagaku Kogyo), Denkabutyral #5000-A (trade name by Denki Kagaku Kogyo), Denkabutyral #6000-CS (trade name by Denki Kagaku Kogyo), Denkabutyral #6000-AS (trade name by Denki Kagaku Kogyo), Denkabutyral #3000-1 (trade name by Denki Kagaku Kogyo), E-LEC KS-1 (trade name by Sekisui Chemical Industry), E-LEC KS-5 (trade name by Sekisui Chemical Industry), E-LEC BX-1 (trade name by Sekisui Chemical Industry), E-LEC BX-5 (trade name by Sekisui Chemical Industry), etc.

Preferably, the binder resin is in the dye layer of the thermal transfer sheet of the invention preferably in an amount of from 30 to 70% by mass of the layer, more preferably from 40 to 60% by mass.

### [Dye Barrier Layer]

The thermal transfer sheet of the invention may have a dye barrier layer between the dye layer and the support.

### [Easy-Adhesion Treatment, Easy-Adhesion Layer]

The support surface may be processed for easy-adhesion treatment for the purpose of enhancing the wettability thereof with a coating liquid and enhancing the adhesiveness thereof. Examples of the treatment include known resin surface modification techniques of, for example, corona discharge treatment, flame treatment, ozone treatment, UV treatment, radiation treatment, surface-roughening treatment, chemical treatment, vacuum plasma treatment, atmospheric plasma treatment, primer treatment, grafting treatment, etc.

An easy-adhesion layer may be formed on the support by coating. Examples of the resin for use in the easy-adhesion layer include vinyl resins such as polyester resins, polyacrylate resins, polyvinyl acetate resins, polyvinyl chloride resins, polyvinyl alcohol resins; polyvinyl acetal resins such as polyvinyl acetacetal, polyvinyl butyral; polyether resins, polyurethane resins, styrene acrylate resins, polyacrylamide resins, polyamide resins, polystyrene resins, polyethylene resins, polypropylene resins, etc.

In case where the film to be used for the support is produced through melt extrusion, the unstretched film may be coated and then it may be stretched.

Two or more different types of the above-mentioned treatments may be combined in the invention.

### [Transfer Protective Layer Laminate]

The transferable protective layer laminate is a laminate generally comprising a release layer, a protective layer and an adhesive layer.

Preferably, the thermal transfer sheet of the invention has a transferable protective layer laminate as formed in a frame sequential made on the support thereof. The transferable protective layer laminate is for forming a protective layer of a transparent resin on a thermally-transferred image through thermal transfer thereon to thereby cover and protect the image, and this is for enhancing the durability of the image such as the wear resistance, the lightfastness and the weather resistance thereof. This is effective in case where the image durability such as the lightfastness, the wear resistance, the chemical resistance and the like is insufficient when the transferred dye is kept exposed out on the surface of the image-receiving sheet.

The transferable protective layer laminate may be formed on the support in an order of the release layer, the protective layer and the adhesive layer thereof from the side of the support. The protective layer may be formed of plural layers. In case where the protective layer serves also as the other layers, the release layer and the adhesive layer may be omitted. As the support, one previously having an adhesive layer formed thereon may also be used.

### [Protective Layer]

The resin to form the protective layer for use in the invention is preferably one excellent in the wear resistance, the chemical resistance, the transparency and the hardness. For example, usable are polyester resins, acrylic resins, polystyrene resins, polyurethane resins, acrylurethane resins, those resins modified with silicone resin, UV-shielding resins, mixtures of those resins, ionizing radiation-curable resins, UV-curable resins, etc. Above all, preferred are polyester resins and acrylic resins.

The resins may be crosslinked with various crosslinking agents.

The acrylic resins are known polymers of at least one monomer selected from acrylate monomers and methacrylate monomers, and may be copolymerized with any other comonomer than the acrylic monomer, such as styrene, acrylonitrile or the like. As a preferred monomer, methyl methacrylate is in the polymer in a polymerization ratio by mass of at least 50% by mass.

The acrylic resins for use in the invention preferably have a molecular weight of from 20,000 to 100,000. When the molecular weight is less than 20,000, oligomers may form during the polymer production, and the polymer produced could not have a stable quality; but when more than 100,000, the foil-cutting in transferring the protective layer may worsen.

As the polyester resin in the invention, usable are conventional know saturated polyester resins. In case where the polyester resin is used, its glass transition temperature is preferably from 50 to 120° C., and its molecular weight is preferably from 2,000 to 40,000, more preferably from 4,000 to 20,000. Falling within the range, the resin is favorable as the foil cutting property thereof in transferring the protective layer may be good.

### (UV Absorbent)

In the protective layer transfer sheet of the invention, the protective layer may contain a UV absorbent. As the UV absorbent, usable is any known inorganic UV absorbent or organic UV absorbent. The organic UV absorbent includes salicylate-based, benzophenone-based, benzotriazole-based, triazine-based, substituted acrylonitrile-based, or hindered amine-based non-reactive UV absorbents, and those derived from such non-reactive UV absorbents by introducing thereinto an addition-polymerizing double bond-having group such as a vinyl group, an acryloyl group or a methacryloyl group, or an alcoholic hydroxyl group, an amino group, a carboxyl group, an epoxy group, an isocyanate group or the like, or by copolymerizing or grafting a thermoplastic resin such as an acrylic resin with the UV absorbent. Disclosed is a method of dissolving a UV absorbent in a resin monomer or oligomer followed by polymerizing the monomer or oligomer (JP-A 2006-21333), and the UV-shielding resins thus produced are also usable herein. In this case, the UV absorbent may be a non-reactive one.

Of such UV absorbents, especially preferred are benzophenone-based, benzotriazole-based or triazine based UV absorbents. Preferably, the UV absorbents are combined for use herein in such a manner that the combined mixture can cover the effective UV absorption wavelength range in accordance with the characteristics of the dye to be used for image formation. Preferably, non-reactive UV absorbents having different structures are combined so that the UV absorbents used in the thermal transfer sheet do not precipitate out.

UV absorbents usable herein are available as commercial products, such as Tinuvin P (by Ciba-Geigy), JF-77 (by Johoku Chemical), Seesorb 701 (by Shiraishi Calcium), Sumisorb 200 (by Sumitomo Chemical), Biosorb 520 (by Kyodo Chemical), Adekastab LA-32 (by Adeka), etc.

When an ionizing radiation-curable resin or a UV-curable resin is used, a protective layer especially excellent in the plasticizer resistance and the wear resistance can be formed. Concretely, the protective layer may be formed by crosslinking and curing a radical-polymerizing polymer or oligomer through irradiation with ionizing radiation. In this case, if desired, a photopolymerization initiator may be added for polymerization and crosslinking with electron beams or UV rays. In addition, known ionizing radiation-curable resins are also usable.

### (Filler)

In the invention, a filler is preferably used. The organic filler and/or the inorganic filler usable herein include polyethylene wax, bisamide, nylon, acrylic resin, crosslinked polystyrene, silicone resin, silicone rubber, talc, calcium carbonate, titanium oxide, alumina, and silica particles such as micro silica, colloidal silica. In the thermal transfer sheet of the invention, the filler to be used is not limited to these, but any other known one can also be used favorably.

Preferably, the organic filler and/or the inorganic filler for use herein are those having a particle size of at most 10 μm, more preferably from 0.1 to 3 μm, and having good lubricity and high transparency. The amount of the filler to be added is preferably such that the transferred layer could be transparent, concretely falling within a range of from 0 to 100 parts by mass relative to 100 parts by mass of the resin.

The method of forming the protective layer depends on the type of the resin to be used. Preferably, the protective layer is formed in the same manner as that for the dye layer mentioned in the above, and its amount is preferably from 0.5 to 10 μm.

### [Release Layer, Peeling Layer]

In case where the transferable protective layer laminate is used and where the protective layer is hardly peeled away from the support, a release layer may be formed between the support and the protective layer. A peeling layer may be formed between the transferable protective layer and the release layer. The release layer may be formed, for example, by coating with a coating liquid that contains at least one of wax, silicone wax, silicone resin, fluororesin, acrylic resin, polyvinyl alcohol resin, cellulose derivative resin, urethane resin, vinyl acetate resin, acryl vinyl ether resin, maleic anhydride resin and copolymer of those resins, according to a conventional known method of gravure coating, gravure reverse coating or the like, followed by drying it. Of the above-mentioned resins, preferred are acrylic resins formed by homopolymerization of acrylic acid, methacrylic acid or the like monomer alone or by copolymerization thereof with any other monomer, or cellulose derivative resins, as they are excellent in the adhesiveness to the support and in the peelability from the protective layer.

The layer may be crosslinked with various crosslinking agents; and ionizing radiation-curable resins and UV-curable resins may also be used for the layer.

The release layer may be one that is transferred onto a transfer object through thermal transfer, or one that remains on the side of the support, or one that undergoes cohesive failure, and any of these may be suitably used herein. As one preferred embodiment, the release layer is non-transferable, and remains on the side of the support through thermal transfer so that the interface between the release layer and the thermal transferable protective layer could still serve as the surface of the protective layer after thermal transfer, from the viewpoint of the surface glossiness and the transfer stability of the protective layer. The release layer may be formed according to a conventional known coating method, and its thickness is preferably from 0.5 to 5 μm in dry.

### [Adhesive Layer]

An adhesive layer may be provided as the outermost layer of the transferable protective layer laminate, or that is, as the outermost surface of the protective layer. Accordingly, the adhesiveness of the protective layer to the transfer subject may be bettered.

The adhesive layer may contain an UV absorbent. The UV absorbent may be the same as that used in the protective layer, and its preferred range is also the same as that for the protective layer.

### [Back Layer]

Preferably, the thermal transfer sheet of the invention has a back layer on the side (back side) of the support thereof opposite to the side coated with the dye layer, or that is, on the back side to be kept in contact with a thermal head. Also preferably, the protective layer transfer sheet has aback layer on the side (back side) of the support thereof opposite to the side coated with the transferable protective layer, or that is, on the back side to be kept in contact with a thermal head.

When the thermal transfer sheet is heated under the condition where the back of the support of the sheet is kept in direct contact with a heating device such as a thermal head, then the sheet may undergo thermal fusion to the heating device. In addition, the friction between the two is great, and the thermal transfer sheet may be difficult to smoothly move during printing.

The back layer is formed so that the thermal transfer sheet could be resistant to thermal energy given thereto from a thermal head, and this prevent thermal fusion and enables smooth moving. With the recent tendency in the art toward high-speed printing, the thermal energy from thermal head is increasing, and the necessity for the provision of the back layer is increasing.

The back layer may be formed by coating with a coating material prepared by adding a lubricant, a release agent, a surfactant, inorganic particles, organic particles, a pigment or the like to a binder. An interlayer may be formed between the back layer and the support. As the interlayer, disclosed is a layer comprising inorganic fine particles and a water-soluble resin or an emulsifiable hydrophilic resin.

As the binder resin, usable are known resins that are highly resistant to heat. Examples of the resin include single substances or mixture of natural or synthetic resins, for example, cellulose resins such as ethyl cellulose, hydroxycellulose, hydroxypropyl cellulose, methyl cellulose, cellulose acetate, cellulose acetate butyrate, cellulose acetate propionate, nitrocellulose; vinyl resins such as polyvinyl alcohol, polyvinyl acetate, polyvinyl butyral, polyvinyl acetal, polyvinyl acetacetal resin, vinyl chloride/vinyl acetate copolymer, polyvinyl pyrrolidone; acrylic resins such as polymethyl methacrylate, polyethyl methacrylate, polyacrylamide, acrylonitrile/styrene copolymer; polyamide resins, polyimide resins, polyamidimide resins, polyvinyltoluene resins, chromanindene resins, polyester resins, polyurethane resins, polyether resins, polybutadiene resins, polycarbonate resins, polyolefin chloride resins, fluororesins, epoxy resins, phenolic resins, silicone resins, silicone-modified or fluorine-modified urethanes.

For enhancing the heat resistance of the back layer, known is a technique of crosslinking the resin through irradiation with UV rays or electron beams. The resin may also be crosslinked with a crosslinking agent under heat. In this case, a catalyst may be added to the layer. As the crosslinking agent, known are polyisocyanates, etc. For this, suitable is a resin having a hydroxyl group-type functional group. JP-A 62-259889 discloses formation of a back layer by adding a filler such as an alkali metal or alkaline earth metal salt of a phosphate and calcium carbonate to a reaction product of a polyvinyl butyral and an isocyanate compound. JP-A 6-99671 discloses formation of a polymer compound of forming a heat-resistant lubricant layer by reacting an amino group-having silicone compound and an isocyanate compound at least 2 isocyanate groups in one molecule.

In order that the back layer can sufficiently exhibit its function, additives such as a lubricant, a plasticizer, a stabilizer, a filler, a filler for removal of substances adhering to head and the like may be incorporated in the layer.

The lubricant includes solid lubricants of fluorides such as calcium fluoride, barium fluoride, graphite fluoride; sulfides such as molybdenum disulfide, tungsten disulfide, iron sulfide; oxides such as lead oxide, alumina, molybdenum oxide; inorganic compounds such as graphite, mica, boron nitride, clays (talc, acid clay); organic resins such as fluororesins, silicone resins; silicone oils; metal soaps such as metal stearates; waxes such as polyethylene wax, paraffin wax; surfactants such as anionic surfactants, cationic surfactants, ampholytic surfactants, nonionic surfactants, fluorine-containing surfactants, etc.

Phosphate-based surfactants such as zinc salts of alkylphosphoric monoesters or alkylphosphoric diesters may also be usable, but as having an acid radical, these are problematic in that the phosphate moiety may decompose when the quantity of heat given thereto from thermal head increases, and further the pH of the back layer lowers to thereby incerase the corrosion abrasion of thermal head. As opposed to this, known are a method of using a neutralized phosphate-based surfactant, and a method of using a neutralizing agent such as magnesium hydroxide.

As other additives, also mentioned are higher fatty acid alcohols, organopolysiloxanes, organic carboxylic acids and their derivatives, and fine particles of inorganic compounds such as talc, silica, etc.

The back layer may be formed by coating with a coating liquid prepared by dissolving or dispersing a material of additives added to a binder in a solvent, according to a conventional known method of gravure coating, roll coating, blade coating, wire bar coating or the like. The thickness of the layer is preferably from 0.1 to 10 μm, more preferably from 0.5 to 5 μm.

### [Support]

The support of the thermal transfer sheet of the invention and the transferable protective layer laminate for use in the invention is not specifically defined, for which, for example, usable are any known ones having the necessary heat resistance and strength.

For example, there are mentioned polyamide, polyimide and polyester films.

The thickness of the support may be suitably changed in accordance with the material constituting it so that the support may have suitable strength and heat resistance. Preferably, the thickness is from 1 to 100 μm, more preferably from 2 to 50 μm, even more preferably from 3 to 10 μm.

Preferably, the thermal transfer sheet and the transferable protective layer laminate are formed on one and the same support.

### <Thermal Transfer Image-Receiving Sheet>

The thermal transfer image-receiving sheet (hereinafter this may be simply referred to as “image-receiving sheet”) for use in the invention is described below.

The image-receiving sheet for use herein has at least one dye-receiving layer (hereinafter this may be simply referred to as “receiving layer”) on a support, in which interlayers such as heat-insulating layer (porous layer), gloss-controlling layer, white background-controlling layer, charge-controlling layer, adhesive layer, primer layer or the like may be formed between the support and the receiving layer. An undercoat layer may be formed between the functional and the support. In one preferred embodiment, at least one heat-insulating layer is formed between the support and the receiving layer.

Preferably, the receiving layer and the interlayer are formed according to a simultaneous multi-coating method, and if desired, plural interlayers may be formed in one sheet.

On the back of the support, a curl-controlling layer, a writing layer and a charge-controlling layer may be formed. The layers on the back of the support may be formed according to an ordinary coating method of roll coating, bar coating, gravure coating, gravure reverse coating or the like.

### [Receiving Layer]

The thermal image-receiving sheet has at least one receiving layer that contains a dye-receiving, thermoplastic receiving polymer. The receiving layer may contain a UV absorbent, a release agent, a lubricant, an antioxidant, a preservative, a surfactant and other additives.

### (Thermoplastic Resin)

A known thermoplastic resin may be used in the receiving layer in the invention.

Preferred examples of the thermoplastic resin include polycarbonate, polyester, polyurethane, polyvinyl chloride and their copolymers, and styrene/acrylonitrile copolymer, polycaprolactone and their mixtures. More preferred are polyester, polyvinyl chloride and their copolymers and mixtures. The polymers may be used either singly or as their mixture.

The polymer for use herein is dissolved suitably in an organic solvent (methyl ethyl ketone, ethyl acetate, toluene, xylene, etc.), and the solution may be applied to a support. Alternatively, the polymer latex may be added to a water-base coating liquid, and this may be applied to a support.

Polyester and polyvinyl chloride are described in more detail hereinunder.

### (Polyester-Type Polymer)

Polyester is produced through polycondensation of a dicarboxylic acid component (including its derivative) and a diol component (including its derivative). The polyester polymer may have an aromatic ring and/or an alicyclic ring. Regarding the alicyclic polyester, the technique described in JP-A 5-238167 is effective from the viewpoint of the dye-taking ability and the image stability.

In the invention, preferably, at least the above-mentioned dicarboxylic component and diol component are used and polycondensed to give a polyester-type polymer having a molecular weight (mass-average molecular weight (Mw)) of generally at least about 11000, preferably at least about 15000, more preferably at least about 17000, and the polyester polymer of the type is preferred for use in the invention. When a polymer having a too low molecular weight is used, then the elasticity of the receiving layer to be formed may be poor, and the heat resistance thereof may also be poor, and in such a case, the image-receiving sheet could not be well released from the thermal transfer sheet attached thereto in image formation. The molecular weight is preferably larger from the viewpoint of increasing the elasticity of the receiving layer. Accordingly, not causing a problem in that the coating liquid could not dissolve in a solvent in receiving layer formation, or a problem in that the adhesiveness of the receiving layer formed by coating and drying to the support is lowered, the uppermost limit of the molecular weight is not specifically defined; however, preferably, it is at most about 30,000, more preferably at most about 25,000. For producing the polyester polymer, usable is any conventional known method.

As saturated polyesters, for example, usable are Vylonal MD-1200, Vylonal MD-1220, Vylonal MD-1245, Vylonal MD-1250, Vylonal MD-1500, Vylonal MD-1930, Vylonal MD-1985 (all trade name by Toyobo), etc.

### (Vinyl Chloride Polymer)

Vinyl chloride polymer, especially copolymer with vinyl chloride for use in the receiving layer is described in detail hereinunder.

Not specifically defined, the monomer to copolymerize with vinyl chloride may be any one capable of copolymerizing with vinyl chloride. Especially preferred are vinyl acetate, acrylates and methacrylates. Preferred examples of the polymer are vinyl chloride/vinyl acetate copolymer, vinyl chloride/acrylate copolymer, and vinyl chloride/methacrylate copolymer. These copolymers are not always limited to only copolymers of a vinyl chloride component and the above-mentioned preferred monomer (vinyl acetate or acrylate or methacrylate), but may be any others containing any other vinyl alcohol component, maleic acid component or the like not interfering with the object of the invention. The other monomer components to constitute the copolymer that comprises vinyl chloride and the above-mentioned preferred monomer include vinyl alcohol and vinyl alcohol derivatives such as vinyl propionate; acrylic acid and methacrylic acid, and acrylic acid and methacrylic acid derivatives such as their methyl, ethyl, propyl, butyl or 2-ethylhexyl esters; maleic acid, and maleic acid derivatives such as diethyl maleate, dibutyl maleate, dioctyl maleate; vinyl ether derivatives such as methyl vinyl ether, butyl vinyl ether, 2-ethylhexyl vinyl ether; and acrylonitrile, methacrylonitrile, styrene, vinyl acetate, etc. The component ratio of vinyl chloride to the above-mentioned preferred monomer in the copolymer may be any desired ratio; however, preferably, the vinyl chloride component accounts for at least 50% by mass of the copolymer. The content of the other components mentioned above, than vinyl chloride and the preferred monomer, is preferably at most 10% by mass.

The vinyl chloride/vinyl acetate copolymer includes Vinybran 240, Vinybran 601, Vinybran 602, Vinybran 380, Vinybran 386, Vinybran 410, Vinybran 550 (all trade names by Nisshin Chemical), etc.

The vinyl chloride/acrylate copolymer includes Vinybran 270, Vinybran 276, Vinybran 277, Vinybran 609, Vinybran 680, Vinybran 690, Vinybran 900 (all trade names by Nisshin Chemical), etc.

### (Polymer Latex)

A polymer latex is preferably used in the invention. The polymer latex is described below.

The polymer latex to be in the receiving layer in the thermal transfer image-receiving sheet for use in the invention is preferably one prepared by dispersing hydrophobic polymer particles in a water-soluble dispersant. The mean particle size of the dispersed particles is preferably from 1 to 50000 nm, more preferably from 5 to 1000 nm.

The polymer latex may be an ordinary one having an ordinary uniform structure, or may a core/shell latex. In the latter case, it is often desirable that the core and the shell differ in the glass transition temperature. The glass transition temperature of the polymer latex for use in the invention is preferably from −30° C. to 130° C., more preferably from 0° C. to 120° C., even more preferably from 10° C. to 100° C.

In the invention, preferably, the receiving layer is formed by coating with a water-base coating liquid followed by drying. However, “water-base” as referred to herein means that at least 60% by mass of the solvent (dispersant) in the coating liquid is water. The other component than water in the coating liquid may be a water-miscible organic solvent such as methyl alcohol, ethyl alcohol, isopropyl alcohol, dimethylformamide, ethyl acetate, diacetone alcohol, furfuryl alcohol, benzyl alcohol, diethylene glycol monoethyl ether, oxyethylene phenyl ether, etc.

The above-mentioned polymer latex for use in the invention may be combined with any other polymer. The polymer that may be combined with the polymer latex is preferably transparent or semitransparent, and colorless. It includes natural resin polymers and copolymers, synthetic resin polymers and copolymers, other film-forming media, such as gelatins, polyvinyl alcohols, hydroxyethyl celluloses, cellulose acetates, cellulose acetate butyrates, polyvinylpyrrolidones.

### (Binder)

The binder for use in the invention is preferably one having a glass transition temperature (Tg) of from −30° C. to 90° C. from the viewpoint of the working brittleness and the image storability, more preferably from −10° C. to 85° C., even more preferably from 0° C. to 70° C. Two or more different types of polymers may be combined for use as the binder. In this case, preferably, the polymers are so combined in consideration of the constitutive components thereof that the weighted mean of Tg may fall within the above-mentioned range. In case where the binder is in phase separation or has a core/shell structure, also preferably the weighted mean of Tg falls within the above-mentioned range.

### (Release Agent)

In the invention, a release agent may be used in the receiving layer for more surely securing the release of the image-receiving sheet from the thermal transfer ink sheet in image formation by printing.

As the release agent, for example, usable are solid waxes such as polyethylene wax, amide wax; silicone oils, phosphate compounds, fluorine-containing surfactants, silicone surfactants and other release agents known in this technical field. Preferred are fluorine compounds such as fluorine-containing surfactants; and silicone compounds such as silicone surfactants, silicone oils and/or their cured products.

The coating amount of the receiving layer is preferably from 0.5 to 10 g/m² (as solid content—unless otherwise specifically indicated in this description, the coating amount is a numerical value in terms of the solid content of the coating layer).

### [Release Layer]

A cured modified silicone oil may be added not to the receiving layer but to a release layer formed on the receiving layer. Also in this case, the above-mentioned receiving layer may be used, and silicone may be added to the receiving layer. The release layer contains a cured modified silicone; and the type of the silicone to be used and the method of using it are the same as in the case of using it in the receiving layer. In case where a catalyst or a retardant is used, it may also be added like in the receiving layer. The release layer may be formed of a silicone alone, but may contain, as a binder, a miscible resin as combined. The thickness of the release layer may be from 0.001 to 1 g/m².

### [Heat-Insulating Layer]

### (Hollow Polymer)

In the image-receiving sheet for use in the invention, the heat-insulating layer preferably contain a hollow polymer and a water-soluble polymer.

The hollow polymer for use in the invention is polymer particles having a void inside the particle. For example, it includes [1] non-foaming hollow polymer particles of such that a dispersant such as water is inside the partitioning walls formed of polystyrene, acrylic resin, styrene-acrylic resin or the like, and after coating and drying, the dispersant inside the particles is evaporated away from the particles to give hollow particles; [2] foaming microballoons of such that a low-boiling-point liquid such as butane, pentane or the like is enveloped with a resin comprising any of polyvinylidene chloride, polyacrylonitrile, polyacrylic acid, polyacrylate, or their mixture or polymer, and after coating, the low-boiling-point liquid inside the particles is expanded to give a hollow space inside the foamed particles; [3] microballoons prepared by previously heating and foaming the above [2] to be a hollow polymer; etc.

The particle size of the hollow polymer is preferably from 0.1 to 20 μm, more preferably from 0.1 to 5.0 μm, even more preferably from 0.2 to 3.0 μm, still more preferably from 0.3 to 1.0 μm.

The void ratio of the hollow polymer is preferably from 20 to 70%, more preferably from 20 to 50%. The void ratio of the hollow polymer is the ratio of the void part volume to the particle volume.

Preferably, the glass transition temperature (Tg) of the hollow polymer is not lower than 70° C., more preferably not lower than 90° C. If desired, two or more different types of hollow polymers may be used as combined.

The hollow polymers are available on the market. Examples of the above [1] are Rohm & Haas's Ropaque 1055, DIC's Boncoat PP-1000, JSR's SX866(B), Zeon's Nipol MH5055 (all trade names), etc. Examples of the above [2] are Matsumoto Yushi's F-30, F-50 (both trade names), etc. Examples of the above [3] are Matsumoto Yushi's F-30E, Nippon Ferrite's Expancel 461DE, 551DE, 551DE20 (all trade names), etc. Of those, more preferred for use herein are the hollow polymers of the above [1].

### (Water-Soluble Polymer)

As the binder in the heat-insulating layer, usable is a water-soluble polymer. The water-soluble polymer for use in the heat-insulating layer is preferably a polymer capable of being combined with the polymer latex.

In the invention, the water-soluble polymer used as a binder in the heat-insulating layer is preferably polyvinyl alcohol or gelatin, most preferably gelatin.

The water-soluble polymer in the heat-insulating layer may be crosslinked with a hardening agent for controlling the cushion property and the film strength of the sheet. In case where the polymer is crosslinked with a hardening agent, the hardening agent to be used is preferably one selected from H-1, 4, 6, 8 and 14 in JP-A 1-214845, page 17; compounds of formulae (VII) to (XII) (H-1 to 54) in U.S. Pat. No. 4,618,573, columns 13 to 23; compounds of formula (6) (H-1 to 76) in JP-A 2-214852, page 8, right lower section; more preferably H-14, and the compounds described in claim 1 in U.S. Pat. No. 3,325,287.

### [Support]

Not specifically defined, the support of the thermal transfer image-receiving sheet may be any known coated paper, laminate paper or synthetic paper.

### [Curl-Controlling Layer, Writing Layer, Charge-Controlling Layer]

The thermal transfer image-receiving sheet for use in the invention may have, if desired, a curl-controlling layer, a writing layer and a charge-controlling layer formed on the other surface (back) of the support thereof opposite to the surface coated with the receiving layer.

### <Image Formation Method>

In the image formation method of the invention, the thermal transfer image-receiving sheet and the thermal transfer sheet are put one upon another in such a manner that the receiving layer of the former may face the dye layer of the latter, and thermal energy is given thereto from a thermal head in accordance with image signals to form an image.

Regarding the details of the method, for example, referred to are those of the method described in JP-A 2005-88545. In the invention, from the viewpoint of shortening the time to be taken before prints are provided to consumers, the printing time is preferably less than 15 seconds, more preferably from 3 to 12 seconds, even more preferably from 3 to 7 seconds.

For satisfying the above-mentioned printing time, the line speed in printing is preferably at most 0.73 msec/line, more preferably at most 0.65 msec/line. From the viewpoint of enhancing the transfer efficiency under high-speed processing condition, the ultimate temperature of the thermal head in printing is preferably from 180° C. to 450° C., more preferably from 200° C. to 450° C., even more preferably from 350° C. to 450° C.

The invention is applicable to printers, copiers and the like to be driven in a thermal transfer recording system. The means of imparting thermal energy in thermal transfer may be any conventional known means. For example, using a recording apparatus such as a thermal printer (e.g., Hitachi's trade name, Video Printer VY-100) or the like, the recording time may be controlled, and thermal energy on a level of from 5 to 100 mJ/mm² or so may be given to fully attain the intended object. By suitably selecting the support in the thermal transfer image-receiving sheet for use in the invention, the invention is applicable to various applications of thermally-transferable sheet-fed or roll thermal transfer image-receiving sheets, cards, transparent sheets for manuscript formation, etc.

### EXAMPLES

The invention is described in more detail with reference to the following Examples. In these Examples, the material used, its amount and the ratio, the details of the treatment and the treatment process may be suitably modified or changed. Accordingly, the invention should not be limited by these Examples. In the Examples, part or % is by mass unless otherwise specifically indicated.

### Example 101

### Production of Thermal Transfer Sheet

### (Preparation of Coating Liquids for Production of Thermal Transfer Sheet)

The following coating liquids were prepared for producing a thermal transfer sheet. Of those, a specific polymer P-20 in the invention was added to the dye coating liquids of yellow, magenta and cyan.

### Back Layer Coating Liquid:

| | |
|---|---|
| Acrylic polyol resin (Acrydic A-801, trade | 26.0 mas. pts. |
| name by DIC) | |
| Zinc stearate (SZ-2000, trade name by Sakai | 0.43 mas. pts. |
| Chemical Industry) | |
| Phosphate (Prisurf A217, trade name by | 1.27 mas. pts. |
| Daiichi Kogyo Seiyaku) | |
| Isocyanate (50% solution) (Burnock D-800, | 8.0 mas. pts. |
| trade name by DIC) | |
| Methyl ethyl ketone/toluene (2/1 by mass) | 64 mas. pts. |

### Yellow Dye Layer Coating Liquid:

| | |
|---|---|
| Yellow dye Y4-2 | 3.7 mas. pts. |
| Yellow dye Y7-4 | 3.9 mas. pts. |
| Polyvinyl acetacetal resin (E-LEC KS-1, trade | 8.5 mas. pts. |
| name by Sekisui Chemical Industry) | |
| Polyvinyl butyral resin (Denkabutyral #6000-C, | 0.2 mas. pts. |
| trade name by Denki Kagaku Kogyo) | |
| Compound P-20 of the invention | 0.2 mas. pts. |
| Mat agent (FLO-THENE UF, trade name by | 0.15 mas. pts. |
| Sumitomo Seika) | |
| Methyl ethyl ketone/toluene (2/1 by mass) | 82 mas. pts. |

### Magenta Dye Layer Coating Liquid:

| | |
|---|---|
| Magenta Dye M3-1 | 1.2 mas. pts. |
| Magenta Dye M3-2 | 6.0 mas. pts. |
| Cyan Dye C1-2 | 0.4 mas. pts. |
| Polyvinyl acetacetal resin (E-LEC KS-1, trade | 9.0 mas. pts. |
| name by Sekisui Chemical Industry) | |
| Polyvinyl butyral resin (Denkabutyral #6000-C, | 0.2 mas. pts. |
| trade name by Denki Kagaku Kogyo) | |
| Compound P-20 of the invention | 0.2 mas. pts. |
| Mat agent (FLO-THENE UF, trade name by | 0.15 mas. pts. |
| Sumitomo Seika) | |
| Methyl ethyl ketone/toluene (2/1 by mass) | 83 mas. pts. |

### Cyan Dye Layer Coating Liquid:

| | |
|---|---|
| Cyan Dye C1-2 | 1.4 mas. pts. |
| Cyan Dye C3-1 | 6.4 mas. pts. |
| Polyvinyl acetacetal resin (E-LEC KS-1, trade | 8.5 mas. pts. |
| name by Sekisui Chemical Industry) | |
| Polyvinyl butyral resin (Denkabutyral #6000-C, | 0.2 mas. pts. |
| trade name by Denki Kagaku Kogyo) | |
| Compound P-20 of the invention | 0.2 mas. pts. |
| Mat agent (FLO-THENE UF, trade name by | 0.15 mas. pts. |
| Sumitomo Seika) | |
| Methyl ethyl ketone/toluene (2/1 by mass) | 83 mas. pts. |

### Release Layer Coating Liquid:

| | |
|---|---|
| Modified cellulose resin (L-30, | 5 mas. pts. |
| trade name by Daicel Chemical) | |
| Methyl ethyl ketone | 95 mas. pts. |

### Protective Layer Coating Liquid:

| | |
|---|---|
| Acrylic resin solution (solid content 40%) | 90 mas.pts. |
| (UNO-1, trade name by Gifu Ceramic) | |
| Methanol/isopropanol (1/1 by mass) | 10 mas.pts. |

### Adhesive Layer Coating Liquid:

| | | |
|---|---|---|
| Acrylic resin (Dianal BR-77, trade name by | 25 | mas.pts. |
| Mitsubishi Rayon) | | |
| UV absorbent UV-1 mentioned below | 1 | mas.pt. |
| UV absorbent UV-2 mentioned below | 2 | mas.pts. |
| UV absorbent UV-3 mentioned below | 1 | mas.pt. |
| UV absorbent UV-4 mentioned below | 1 | mas.pt. |
| PMMA particles | 0.4 | mas.pts. |
| Methyl ethyl ketone/toluene (2/1 by mass) | 70 | mas.pts. |

(UV-1) 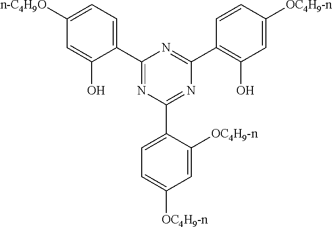
(UV-2) 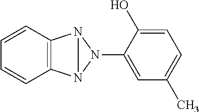
(UV-3) 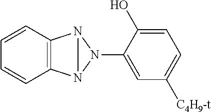
(UV-4)

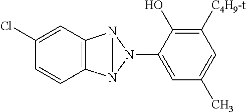

### (Production of Thermal Transfer Sheet)

The back layer coating liquid was applied to a support of 6.0-μm thick polyester film, of which one surface had been processed for easy adhesion, (Diafoil K200E-6F, trade name by Mitsubishi Polyester Film), on the other surface thereof opposite to the easy adhesion-processed surface, to be a coating amount as the solid content after dried of 1 g/m². After coated, this was cured by heat treatment at 60° C.

The yellow, magenta and cyan dye layers and the transferable protective layer laminate mentioned above were formed on the side of the easy-adhesion layer of the thermally-cured polyester film, in a frame sequential mode, thereby producing a thermal transfer sheet A. In forming the transferable protective layer laminate, the release layer coating liquid was applied, then dried, and thereafter the protective layer coating liquid was applied and dried, and further the adhesive layer coating liquid was applied thereon. The coating amount of each layer was so controlled that the dry coating amount as the solid content thereof could be as follows:

| | |
|---|---|
| Yellow dye layer | 0.8 g/m² |
| Magenta dye layer | 0.8 g/m² |
| Cyan dye layer | 0.8 g/m² |
| Release layer | 0.3 g/m² |
| Protective layer | 0.5 g/m² |
| Adhesive layer | 2.2 g/m² |

### Example 102

A thermal transfer sheet was produced in the same manner as in Example 101, for which, however, the compound P-2 of the invention was added to each dye layer in place of the compound P-20.

| | |
|---|---|
| Compound P-2 of the invention | 0.2 mas. pts. |

### Example 103

A thermal transfer sheet was produced in the same manner as in Example 101, for which, however, the compound P-3 of the invention was added to each dye layer in place of the compound P-20.

| | |
|---|---|
| Compound P-3 of the invention | 0.2 mas. pts. |

### Example 104

A thermal transfer sheet was produced in the same manner as in Example 101, for which, however, the compound P-11 of the invention was added to each dye layer in place of the compound P-20.

| | |
|---|---|
| Compound P-11 of the invention | 0.2 mas. pts. |

### Example 105

A thermal transfer sheet was produced in the same manner as in Example 101, for which, however, the compound P-12 of the invention was added to each dye layer in place of the compound P-20.

| | |
|---|---|
| Compound P-12 of the invention | 0.2 mas. pts. |

### Example 106

A thermal transfer sheet was produced in the same manner as in Example 101, for which, however, the compound P-30 of the invention was added to each dye layer in place of the compound P-20.

| | |
|---|---|
| Compound P-30 of the invention | 0.2 mas. pts. |

### Example 107

A thermal transfer sheet was produced in the same manner as in Example 101, for which, however, the following compounds of the invention were added to each dye layer in place of the compound P-20.

| | |
|---|---|
| Compound P-20 of the invention | 0.1 mas. pts. |
| Compound P-30 of the invention | 0.1 mas. pts. |

### Example 108

A thermal transfer sheet was produced in the same manner as in Example 101, for which, however, the following compounds were added to each dye layer in place of the compound P-20.

| | |
|---|---|
| Compound P-20 of the invention | 0.2 mas. pts. |
| Release agent (X-22-3000T, trade name | 0.03 mas. pts. |
| by Shin-etsu Chemical Industry) | |
| Release agent (TSF4701, trade name by | 0.02 mas. pts. |
| Momentive Performance Materials Japan) | |

### Comparative Example 101

A thermal transfer sheet was produced in the same manner as in Example 101, for which, however, the following comparative compounds were added to each dye layer in place of the compound P-20.

| | |
|---|---|
| Comparative compound 1 (X-22-3000T, trade | 0.05 mas. pts. |
| name by Shin-etsu Chemical Industry) | |
| Comparative compound 2 (TSF4701, trade name | 0.03 mas. pts. |
| by Momentive Performance Materials Japan) | |

### Comparative Example 102

A thermal transfer sheet was produced in the same manner as in Example 101, for which, however, the following comparative compounds were added to each dye layer in place of the compound P-20.

| | |
|---|---|
| Comparative compound 1 (X-22-3000T, trade | 0.13 mas. pts. |
| name by Shin-etsu Chemical Industry) | |
| Comparative compound 2 (TSF4701, trade name | 0.07 mas. pts. |
| by Momentive Performance Materials Japan) | |

### Comparative Example 103

A thermal transfer sheet was produced in the same manner as in Example 101, for which, however, the following comparative compound 3 was added to each dye layer in place of the compound P-20.

| | |
|---|---|
| Comparative compound 3 | 0.2 mas.pts. |

Comparative Compound 3:

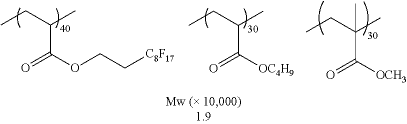

### Comparative Example 104

A thermal transfer sheet was produced in the same manner as in Example 101, in which, however, the compound of the invention was not used.

### [Production of Thermal Transfer Image-Receiving Sheet]

The surface of a paper support double-laminated with polyethylene was processed for corona discharge treatment, and then a sodium dodecylbenzenesulfonate-containing gelatin undercoat layer was formed on it. On this, a heat-insulating layer and a receiving layer each having the composition mentioned below were laminated by coating in that order from the side of the support, according to the method illustrated in FIG. 9 in U.S. Pat. No. 2,761,791. The dry coating amount of the undercoat layer was 6.7 g/m², that of the heat-insulating layer was 8.6 g/m², that of the lower receiving layer was 2.6 g/m², and that of the upper receiving was 2.7 g/m².

### Upper Receiving Layer:

| | |
|---|---|
| Vinyl chloride latex (as solid content) (Vinybran | 22.2 mas. pts. |
| 900, trade name by Nisshin Chemical Industry) | |
| Vinyl chloride latex (as solid content) (Vinybran | 2.5 mas. pts. |
| 276, trade name by Nisshin Chemical Industry) | |
| Gelatin | 0.5 mas. pts. |
| Ester wax EW-1 mentioned below | 2.0 mas. pts. |
| Surfactant F-1 mentioned below | 0.04 mas. pts. |

### Lower Receiving Layer:

| | |
|---|---|
| Vinyl chloride latex (as solid content) (Vinybran | 24.4 mas. pts. |
| 690, trade name by Nisshin Chemical Industry) | |
| Gelatin | 1.4 mas. pts. |
| Surfactant F-1 mentioned below | 0.04 mas. pts. |

### Heat-Insulating Layer:

| | |
|---|---|
| Hollow polymer particle latex (as solid content) | 579 mas. pts. |
| (MH5055, trade name by Nippon Zeon) | |
| Gelatin | 279 mas. pts. |

### Undercoat Layer:

| | | |
|---|---|---|
| Polyvinyl alcohol (Poval PVA205, trade name by Kuraray) | 16.8 | mas.pts. |
| Styrene butadiene rubber latex (as solid content) (SN-307, | 150 | mas.pts. |
| trade name by Nippon A & L) | | |
| Surfactant F-1 mentioned below | 0.1 | mas.pts. |

(EW-1) 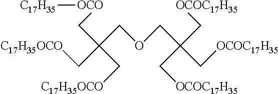
(F-1)

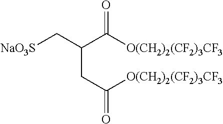

### [Image Formation]

The thermal transfer sheets of Examples 101 to 108 and Comparative Examples 101 to 104, and the thermal transfer image-receiving sheet 201 were worked so that they could be charged in FUJIFILM's sublimation-type thermal transfer printer ASK2000 (trade name), and prints were made on the sheet in a high-speed printing mode. In this case, the line speed was 0.73 msec/line, and the ultimate temperature of TPH was 400° C.

### [Evaluation Test]

### (Printing Failure)

The printing failure was evaluated as follows: The printer was left in a room conditioned at 40° C. and 90% RH for 5 hours, and then 30 copies were made in a continuous printing mode each with a digital image information of KG-size gray solid and KG-size black solid ((R,G,B)=(0,0,0)) printed thereon. Three 27th to 30th copies were checked for the level of printing failure of image defect or image unevenness to be caused by fusion, adhesion or ink peeling. Ten panelists checked the copies according to the following evaluation ranks, and their points were averaged. The results are shown in Table 22 below.

1: With many printing failures, the sample is on a level of unrecognizable print images.
2: With some printing failures, the sample is on a level of impracticability.
3: With some but a few printing failures, the sample is on a level of practicability.
4: Few printing failures.
5: No printing failure.

### (Wrinkling)

The thermal transfer sheets were checked for wrinkling, as follows: The printer was left in a room conditioned at 20° C. and 15% RH for 5 hours, and then 20 copies were made in a continuous printing mode each with a digital image information of KG-size black solid ((R,G,B)=(0,0,0)) printed thereon. Two 19th and 20th copies were quantitatively checked for the level of sheet wrinkling according to the method mentioned below, and the data were averaged.

Using Seiko Epson's network scanner ES-2200, a printing image information under the condition of 24 bit color and 400 dpi was inputted, and processed for bmp data filing. In the image information inputting, the image center part of 98% was used for image analysis for removing the noise information in the panel edges. The image analysis for wrinkling of the thermal transfer sheet was attained as follows. Of the data file, the information G of the strongest luminosity factor was extracted, and the ratio of the pixels failed in black reproduction of at least 25 informations to the total pixels was defined as a wrinkle formation percentage Rs. Samples in which the number of wrinkles formed was smaller have a smaller Rs; but those in which the number of wrinkles formed was larger have a larger Rs. Fused samples could not be checked, and their evaluation was impossible. The results are shown in Table 22 below.

### (Bleeding of Dye)

The samples were checked for color staining on the white background thereof to be caused by dye bleeding, as follows:

The thermal transfer sheets of Examples 101 to 108 and Comparative Examples 101 to 104 were stored under a forced aging condition of 60° C. and 80% RH for 48 hours. Using the thus-aged samples, an image was outputted on 5 white background sheets in an environment of 25° C. and 80% RH. The printed samples were checked for color staining on the white background thereof.

Ten panelists checked the samples according to the following criteria of 1 to 5 ranks. The points of the ten panelists were averaged. The results are shown in Table 22 below.

### (Degree of Color Staining in White Background)

### 1: Extremely bad.

### 2: Bad.

3: Stained, and on a level of impracticability.
4: Good, and on a level of practicability.

### 5: Excellent.

TABLE 22

| | | | Color Staining |
|---|---|---|---|
| Thermal Transfer | Printing | Wrinkling | in White |
| Sheet | Failure | Rs | Background |
| Example 101 | 4.8 | 23 ppm | 4.7 |
| Example 102 | 4.7 | 56 ppm | 4.6 |
| Example 103 | 4.7 | 60 ppm | 4.5 |
| Example 104 | 4.8 | 42 ppm | 4.6 |
| Example 105 | 4.8 | 35 ppm | 4.7 |
| Example 106 | 4.8 | 22 ppm | 4.7 |
| Example 107 | 4.8 | 22 ppm | 4.7 |
| Example 108 | 4.8 | 84 ppm | 4.5 |
| Comparative | 2.8 | 112 ppm | 4.2 |
| Example 101 | | | |
| Comparative | 4.1 | 1680 ppm | 3.2 |
| Example 102 | | | |
| Comparative | 4.6 | 78 ppm | 3.0 |
| Example 103 | | | |
| Comparative | 1.7 | Fused, and | Fused, and |
| Example 104 | | evaluation | evaluation |
| | | impossible. | impossible. |

The results in Table 22 above confirm that the thermal transfer sheets of the invention are wrinkled little and are stained little on the white background thereof, and are free from a problem of printing failure.

While the present invention has been described in detail and with reference to specific embodiments thereof, it will be apparent to one skilled in the art that various changes and modifications can be made therein without departing from the spirit and scope thereof.

The present disclosure relates to the subject matter contained in Japanese Patent Application No. 049976/2008 filed on Feb. 29, 2008, which is expressly incorporated herein by reference in its entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

1. A thermal transfer sheet having, as provided on a support, a dye layer containing a thermo-transferable dye in a binder resin, wherein the dye layer contains at least one polymer containing a repetitive unit derived from (a) a monomer of the following formula (1) and (b) a monomer having an aliphatic group that has a bridging linkage and has at least 7 carbon atoms: 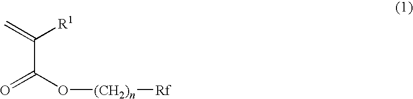
wherein Rf represents substituent containing a fluoroalkyl group having at least 8 fluorine atoms or a perfluoroalkyl group having at least 8 fluorine atoms, n indicates 1 or 2, and R′ represents a hydrogen atom or a methyl group.

2. The thermal transfer sheet according to claim 1, wherein the monomer of the formula (1) is represented by the following formula:
CH₂═CRCO₂(CH₂)ₙCₘF₂ₘ₊₂
wherein n indicates 1 or 2, m indicates an integer of from 4 to 12 and R represents a hydrogen atom or a methyl group.

3. The thermal transfer sheet according to claim 1, wherein the monomer of the formula (1) is represented by the following formula:
CH₂═CRCO₂(CH₂)ₙ(CF₂)ₚH
wherein n indicates 1 or 2, p indicates an integer of from 4 to 12 and R represents a hydrogen atom or a methyl group.

4. The thermal transfer sheet according to claim 1, wherein the monomer of the formula (1) has from 12 to 25 fluorine atoms.

5. The thermal transfer sheet according to claim 1, wherein the monomer having an aliphatic group that has a bridging linkage and has at least 7 carbon atoms is an acrylate, a methacrylate, an acrylamide or a methacrylamide.

6. The thermal transfer sheet according to claim 1, wherein the dye layer comprises three dye layers of yellow, magenta and cyan, as formed in a frame sequential mode on the support.

7. The thermal transfer sheet according to claim 1, wherein at least one transferable protective layer laminate is formed in a frame sequential mode relative to the dye layer.

8. The thermal transfer sheet according to claim 1, wherein the binder resin in the dye layer is represented by the following formula (2): 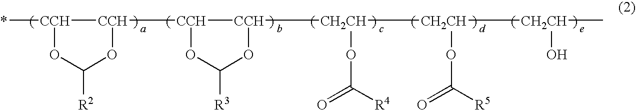
wherein R² to R⁵ each independently represent a substituted or unsubstituted alkyl group having from 1 to 10 carbon atoms, or a substituted or unsubstituted aryl group; a to e each indicate the blend ratio by mass of the constitutive repetitive units; the total of a to e is 100, a and b are independently from 0 to 100, c and d are independently from 0 to 50, e is from 0 to 50, and the total of a and b is from 20 to 100.

9. The thermal transfer sheet according to claim 1, which has a back layer on the side of the support opposite to the side thereof having the dye layer.

10. An image formation method comprising placing the thermal transfer sheet of claim 1 and a thermal transfer image-receiving sheet one upon another in such a manner that the dye layer of the former may face the image-receiving layer of the latter, and imparting thermal energy thereto from a thermal head in accordance with an image signal for image formation on the image receiving sheet.
